(19) United States
(12) Patent Application Publication
(10) Pub. No.: US 2026/0278687 A1
(43) Pub. Date: Sep. 17, 2026

(54) METHOD AND SYSTEM FOR GENERATING A CONTEXTUAL MULTI-ARMED BANDIT MODEL FOR A PERSONALIZED RECOMMENDATION OF A BROKERAGE PRODUCT

(71) Applicant: JPMorgan Chase Bank, N.A., New York, NY (US)

(72) Inventors: Subhabrata DAS, Hoboken, NJ (US); Maryam KABIRI, Allendale, NJ (US); Fernando ACERO MARCHESOTTI, London (GB); Manuel TORRES, Brooklyn, NY (US); Parisa ZEHTABI, London (GB); Harring FIGUEIREDO, Alpharetta, GA (US)

(73) Assignee: JPMorgan Chase Bank, N.A., New York, NY (US)

(21) Appl. No.: 19/079,218

(22) Filed: Mar. 13, 2025

(51) Int. Cl. G06Q 40/06; G06N 3/092

(52) U.S. Cl. CPC G06Q 40/06; G06N 3/092

(57) ABSTRACT

A method and system for generating a contextual multi-armed bandit model for a personalized recommendation of a brokerage product is provided. The method includes receiving input data related to a brokerage product, and extracting contextual features from the input data. The method also includes generating a contextual multi-armed bandit model (CMABM) based on the extracted contextual features representing an arm of the CMABM and based on a selection of at least one learning algorithm from among a plurality of learning algorithms that maximizes an expected reward function for the CMABM. The method also includes predicting an action comprising a personalized recommendation of the brokerage product as derived from the CMABM, and outputting the predicted action to a user.

### FIELD OF THE DISCLOSURE

This technology generally relates to methods and systems for generating a contextual multi-armed bandit model for a personalized recommendation of a brokerage product.

### BACKGROUND INFORMATION

In the context of financial management, such as asset and wealth management, the ability to generate a machine learning model to provide a tailored and customized financial investment product to a client is of paramount importance. This because such a model can dynamically adapt to a real-time change in the financial market landscapes and the client's changing needs.

Current financial models are generally static models that have difficulty in adapting to the real-time changes in the financial market landscape, as well as an evolving need of the client.

Accordingly, there is a need for techniques to generate a machine learning model that can dynamically adapt to real-time changing conditions to provide personalized recommendations of investment products to clients.

### SUMMARY

The present disclosure, through one or more of its various aspects, embodiments, and/or specific features or sub-components, provides, inter alia, various systems, servers, devices, methods, media, programs, and platforms for generating a contextual multi-armed bandit model for a personalized recommendation of a brokerage product.

According to an aspect of the present disclosure, a method of generating a contextual multi-armed bandit model for a personalized recommendation of a brokerage product may be provided. The method may be implemented by at least one processor. The method may include receiving input data related to a brokerage product, and extracting contextual features from the input data. The method may also include generating a contextual multi-armed bandit model (CMABM) based on the extracted contextual features representing an arm of the CMABM and based on a selection of at least one learning algorithm from among a plurality of learning algorithms that maximizes an expected reward function for the CMABM. The method may also include predicting an action comprising a personalized recommendation of the brokerage product as derived from the CMABM, and outputting the predicted action to a user.

The input data may include a user metric and at least one from among a market trend, a product performance metric, and a historical investment data. The user metric may include a user demographic and a user identification. The historical investment data may include at least one from among a historical transaction data, a past action, and a past outcome.

The method may further include training the CMABM based on the historical investment data to estimate a reward associated with the predicted action that maximizes the expected reward function. The method may also include performing a feedback loop mechanism as part of the training of the CMABM. The method may also include updating the CMABM based on an updating rule associated with the selected at least one learning algorithm.

The updating rule comprises at least one from among a predetermined utility maximization rule, a gradient descent function, a distance measurement function, a cosine similarity function, and a probability function. The feedback loop mechanism may be based on a performance evaluation of the CMABM and at least one from among a user feedback and a changing need of a business organization that utilizes the CMABM.

The performance evaluation of the CMABM may include analyzing a performance of the CMABM over a predetermined time period based on computing a suite of performance metrics comprising a precision metric, a recall metric, a mean average precision (MAP) metric, and a normalized discounted cumulative gain (NDCG) metric associated with the CMABM.

The CMABM may include a reinforcement learning model. The plurality of learning algorithms may include a linear greedy learning algorithm, a k-nearest neighbor (KNN) learning algorithm, a randomized popularity learning algorithm, a softmax learning algorithm, a Thompson sampling learning algorithm, a locality-sensitive hashing nearest neighbor (LSHNN) learning algorithm, a cluster learning algorithm, a radius neighborhood learning algorithm, and a tree bandit learning algorithm. The expected reward function may comprise an argmax function with an estimated reward term representing an exploitation concept and a confidence interval representing an exploration concept.

The method may further include optimizing an epsilon-greedy algorithm based on adjusting an epsilon value to provide a balance between an exploitation concept and an exploration concept associated with the CMABM.

According to another embodiment, a computing apparatus for generating a contextual multi-armed bandit model for a personalized recommendation of a brokerage product may be provided. The computing apparatus may include: a processor; a memory; a display; and a communication interface coupled to each of the processor, the memory, and the display.

The processor may be configured to receive input data related to a brokerage product, and extract contextual features from the input data. The processor may also be configured to generate a contextual multi-armed bandit model (CMABM) based on the extracted contextual features representing an arm of the CMABM and based on a selection of at least one learning algorithm from among a plurality of learning algorithms that maximizes an expected reward function for the CMABM. The processor may also be configured to predict an action comprising a personalized recommendation of the brokerage product as derived from the CMABM, and output the predicted action to a user.

The input data may include a user metric and at least one from among a market trend, a product performance metric, and a historical client investment data. The user metric may include a user demographic and a user identification. The historical investment data may include at least one from among a historical transaction data, a past action, and a past outcome.

The processor may also be configured to train the CMABM based on the historical investment data to estimate a reward associated with the predicted action that maximizes the expected reward function. The processor may also be configured to perform a feedback loop mechanism as part of the training of the CMABM. The processor may also be configured to update the CMABM based on an updating rule associated with the selected at least one learning algorithm.

The updating rule may include at least one from among a predetermined utility maximization rule, a gradient descent function, a distance measurement function, a cosine similarity function, and a probability function. The feedback loop mechanism may be based on a performance evaluation of the CMABM and at least one from among a user feedback and a changing need of a business organization that utilizes the CMABM.

The processor may be further configured to perform the evaluation of the CMABM by analyzing a performance of the CMABM over a predetermined time period based on computing a suite of performance metrics comprising a precision metric, a recall metric, a mean average precision (MAP) metric, and a normalized discounted cumulative gain (NDCG) metric associated with the CMABM.

The CMABM may include a reinforcement learning model. The plurality of learning algorithms may include a linear greedy learning algorithm, a k-nearest neighbor (KNN) learning algorithm, a randomized popularity learning algorithm, a softmax learning algorithm, a Thompson sampling learning algorithm, a locality-sensitive hashing nearest neighbor (LSHNN) learning algorithm, a cluster learning algorithm, a radius neighborhood learning algorithm, and a tree bandit learning algorithm. The expected reward function may comprise an argmax function with an estimated reward term representing an exploitation concept and a confidence interval representing an exploration concept.

The processor may be further configured to optimize an epsilon-greedy algorithm based on adjusting an epsilon value to provide a balance between an exploitation concept and an exploration concept associated with the CMABM.

According to yet another embodiment, non-transitory computer readable storage medium storing instructions for may be provided. The non-transitory computer readable storage medium may include executable code which, when executed by a processor, may cause the processor to.

The non-transitory computer readable storage medium may further cause the processor to receive input data related to a brokerage product, and extract contextual features from the input data. The non-transitory computer readable storage medium may further cause the processor to generate a contextual multi-armed bandit model (CMABM) based on the extracted contextual features representing an arm of the CMABM and based on a selection of at least one learning algorithm from among a plurality of learning algorithms that maximizes an expected reward function for the CMABM. The non-transitory computer readable storage medium may further cause the processor to predict an action comprising a personalized recommendation of the brokerage product as derived from the CMABM, and output the predicted action to a user.

The input data may include a user metric and at least one from among a market trend, a product performance metric, and a historical investment data. The user metric may include a user demographic and a user identification. The historical investment data may include at least one from among a historical transaction data, a past action, and a past outcome.

The non-transitory computer readable storage medium may further cause the processor to train the CMABM based on the historical investment data to estimate a reward associated with the predicted action that maximizes the expected reward function. The non-transitory computer readable storage medium may further cause the processor to perform a feedback loop mechanism as part of the training of the CMABM. The non-transitory computer readable storage medium may further cause the processor to update the CMABM based on an updating rule associated with the selected at least one learning algorithm.

The updating rule may include at least one from among a predetermined utility maximization rule, a gradient descent function, a distance measurement function, a cosine similarity function, and a probability function. The feedback loop mechanism may be based on a performance evaluation of the CMABM and at least one from among a user feedback and a changing need of a business organization that utilizes the CMABM. The CMABM may include a reinforcement learning model.

The plurality of learning algorithms comprises a linear greedy learning algorithm, a k-nearest neighbor (KNN) learning algorithm, a randomized popularity learning algorithm, a softmax learning algorithm, a Thompson sampling learning algorithm, a locality-sensitive hashing nearest neighbor (LSHNN) learning algorithm, a cluster learning algorithm, a radius neighborhood learning algorithm, and a tree bandit learning algorithm.

The expected reward function comprises an argmax function with an estimated reward term representing an exploitation concept and a confidence interval representing an exploration concept.

The non-transitory computer readable storage medium may further cause the processor to perform the evaluation of the CMABM by analyzing a performance of the CMABM over a predetermined time period based on computing a suite of performance metrics comprising a precision metric, a recall metric, a mean average precision (MAP) metric, and a normalized discounted cumulative gain (NDCG) metric associated with the CMABM.

The non-transitory computer readable storage medium may further cause the processor to optimize an epsilon-greedy algorithm based on adjusting an epsilon value to provide a balance between an exploitation concept and an exploration concept associated with the CMABM.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for generating a contextual multi-armed bandit model for a personalized recommendation of a brokerage product.

FIG. 4 illustrates a flowchart of a process diagram for generating a contextual multi-armed bandit model for a personalized recommendation of a brokerage product according to an embodiment.

FIG. 5 illustrates an example overview process for generating a contextual multi-armed bandit model for a personalized recommendation of a brokerage product according to an embodiment.

FIG. 6 illustrates example learning algorithms for utilization in the contextual multi-armed bandit model according to an embodiment.

FIG. 7 illustrates an example detailed framework for generating a contextual multi-armed bandit model for a personalized recommendation of a brokerage product according to an embodiment.

### DETAILED DESCRIPTION

In the context of managing client assets, a brokerage product recommendation model utilizing contextual multi-armed bandit model (CMABM) can significantly enhance the services delivered by the business. The CMABM may be particularly applicable in recommending personalized financial products and investment strategies to clients by leveraging client features, investment and wealth data, and assets under management (AUM) value. The terms clients and users may be interchangeably used. The business organization (e.g., a financial firm) may offer a range of financial products, such as, but not limited to, stocks, bonds, mutual funds, and exchange traded funds (ETFs), which may be tailored to meet the specific investment goals and risk profiles of its clients. By incorporating a contextual bandit approach, the CMABM may dynamically learn and adapt to changing client preferences and market conditions, ensuring that the recommendations are continuously optimized for better outcomes.

This personalized recommendation capability is important in serving the diverse needs of high-net-worth individuals, institutional investors, and retail clients, who often seek customized solutions aligned with their financial goals. The CMABM's ability to analyze investment and wealth data, such as risk tolerance and investment objectives, ensures that recommendations are not only personalized but also compliant with regulatory standards, thereby minimizing the risk of unsuitable product offerings.

Furthermore, by considering the AUM value, the CMABM can prioritize recommendations that are most beneficial to both the client and the business organization, potentially maximizing the AUM and, consequently, the revenue generated by the client. In scenarios where the business organization faces potential outstanding or loss dollar amounts due to sub-optimal investment decisions, the CMABM's optimization capability would allow for continuous improvement in the accuracy of its recommendations, thereby reducing the likelihood of financial losses and enhancing overall client satisfaction. This approach positions the business organization as being a proactive and client-centric entity in the competitive landscape of managing client assets and wealth.

Indeed, for a business organization managing a substantial total Assets Under Management (AUM), e.g., but not limited to, $1.1 trillion in total AUM, the technical application of a CMABM as brokerage product recommendation model can be transformative. This because the CMABM can be applied across various exposures, including but not limited to, equities, fixed income, alternative investments, and structured products. By analyzing market exposures, the CMABM tailors its recommendations to align with the risk appetite and investment strategies of individual clients or client segments.

The scope of products that can benefit from the CMABM may include a broad spectrum of financial instruments such as, but not limited to, mutual funds, ETFs, stocks, bonds, options, and more complex derivative products. The CMABM's adaptability allows it to provide real-time, personalized investment recommendations that consider both current market conditions and the unique financial profiles of clients.

In terms of technical applications, the CMABM can be integrated into electronic portfolio management systems, digital client advisory platforms, and electronic automated trading systems. Thus, providing actionable insights that optimize investment portfolios and improve overall client outcomes. The CMABM may also be used to identify cross-selling opportunities by suggesting complementary products that enhance the diversification or performance of existing portfolios.

Given a business organization's significant AUM, the model's ability to make data-driven, context-aware recommendations is crucial in managing large and diverse portfolios. It not only supports the goal of maximizing returns for clients but also aids in mitigating risks associated with market volatility. As such, the model serves as a key tool in maintaining and growing the firm's AUM, while simultaneously enhancing client satisfaction and loyalty in a highly competitive market.

The CMABM can be operated on a continuous and real-time basis, wherein such high frequency is crucial to its effectiveness, as it allows the CMABM to dynamically adjust recommendations in response to changing market conditions, client behaviors, and other relevant factors.

In practice, the CMABM might be updated with each new piece of data that becomes available, such as market price movements, changes in client profiles or preferences, or the execution of previous recommendations. This continuous application ensures that the recommendations remain relevant and aligned with both the client's evolving needs and the current financial landscape.

For example, in a high-frequency trading environment or for clients with highly dynamic portfolios, the CMABM might be applied multiple times per day, even down to the minute or second level. In other contexts, such as longer-term investment strategies, the CMABM might be applied less frequently. In these longer-term investment strategies, the CMABM might perhaps be applied daily or weekly, but it would still operate continuously in the background, ready to update recommendations as soon as new data becomes available.

Thus, the CMABM's real-time application is essential for maximizing its value in managing client assets and wealth, ensuring that it can effectively contribute to portfolio optimization and risk management in a constantly shifting and changing market environment.

Additionally, the CMABM may also provide a balance between the complexity of its machine learning aspects with the need for transparency and accountability in financial decision-making. Indeed, while the CMABM utilizes advanced machine learning techniques that may not be fully interpretable to end-users, sufficient insights into the CMABM's decision-making process may be provided for explainability and accountability.

In the relevant financial sector, clients and regulators demand a certain level of transparency, especially when recommendations involve significant financial implications. Therefore, key justifications behind each recommendation may be provided. For example, the most influential factors (e.g., risk tolerance, market conditions, or past performance, etc.) that led to a particular decision should be provided to the client and highlighted. This level of explainability ensures that the recommendations are not seen as “black box” solutions in order to maintain client trust and meeting regulatory requirements.

Additionally, the CMABM may be continuously monitored and validated as part of an evaluation of the CMABM's performance to gather sufficient details to assess whether the CMABM is functioning as intended and adhering to investment guidelines. This can be particularly important in a high-stakes environment where the CMABM's recommendations can directly impact client portfolios and the business organization's financial outcomes. By performing the continuous monitoring and validating, an optimal balance can be achieved with the clients and regulators being provided with sufficient transparency regarding the CMABM and its operations without overwhelming them with the full complexity of the underlying algorithms that comprise the CMABM.

Thus, the present application improves on the status quo and provides a technological improvement by disclosing techniques and processes related to the CMABM and its generation, which includes training and operation, to improve personalized recommendation of a brokerage product. This may be achieved by providing e.g., personalized recommendation of a brokerage product that aligns with the user's needs. Additionally, the generation of the CMABM in the particular manner as described in the present application also provides a technological improvement through its dynamic analysis, selection, and incorporation of a learning algorithm from a plurality of learning algorithms that best meets the conditions of a given task. Furthermore, the construction of the system operational framework that includes the CMABM along with other technical components to provide the brokerage product recommendation also represents a technological improvement. This framework is further described below.

For these various reasons, the present application provides a technological improvement of the status quo. Further details of the present application are provided below.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

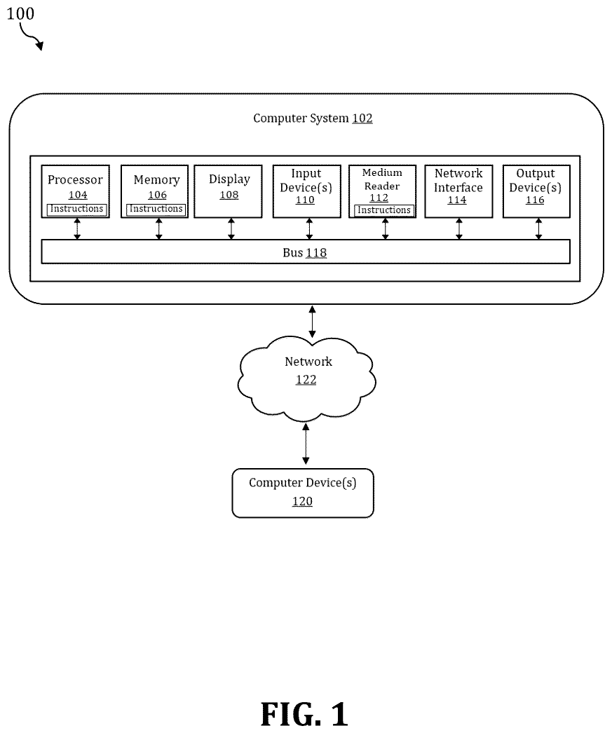

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide for generating a contextual multi-armed bandit model for a personalized recommendation of a brokerage product.

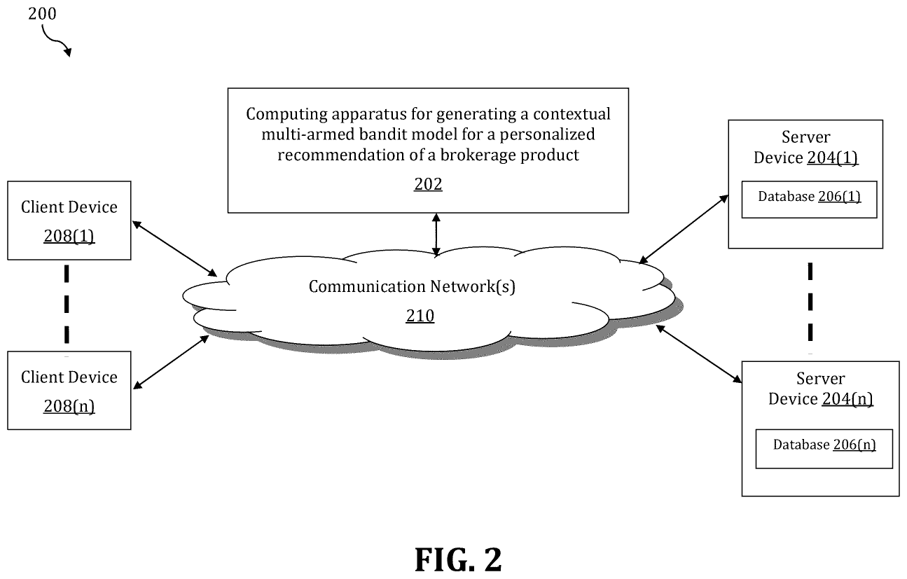

Referring to FIG. 2, a network diagram of a network environment 200 for generating a contextual multi-armed bandit model for a personalized recommendation of a brokerage product may be illustrated. In an embodiment, the method may be executable on any networked computer platform, such as, for example, a personal computer (PC).

The methods for generating a contextual multi-armed bandit model for a personalized recommendation of a brokerage product may be implemented by a computing apparatus 202 that implements a contextual multi-armed bandit model for a personalized recommendation of a brokerage product. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method for generating a contextual multi-armed bandit model for a personalized recommendation of a brokerage product.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

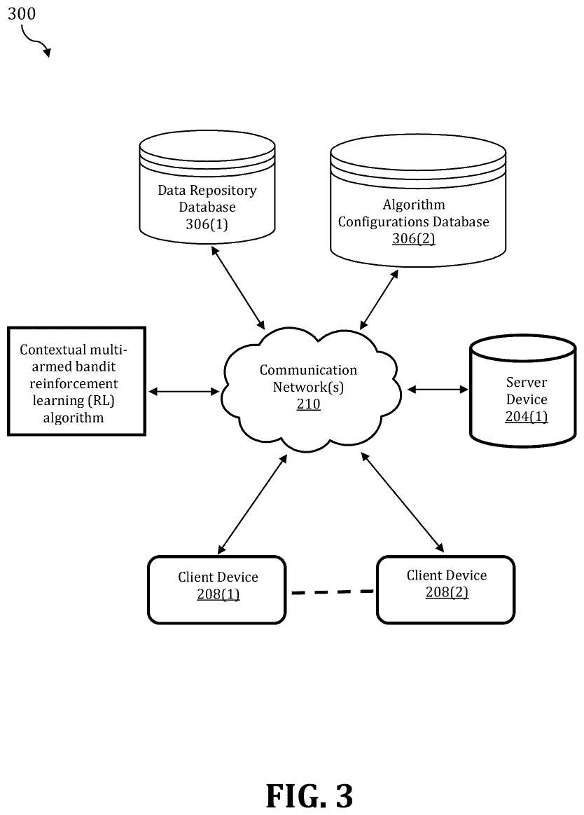

The computing apparatus 202 may be described and illustrated in FIG. 3 as may include a contextual bandit reinforcement learning (RL) algorithm 302, although it may include other rules, algorithms, policies, modules, databases, or applications, for example. As will be described below, the contextual bandit RL algorithm 302 may be configured to implement method of generating a contextual multi-armed bandit model for a personalized recommendation of a brokerage product.

FIG. 3 illustrates a diagram of a system environment 300 for implementing method of generating a contextual multi-armed bandit model for a personalized recommendation of a brokerage product by utilizing the network environment of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository database 306(1) and an algorithm configurations database 306(2). The contextual bandit RL algorithm 302 may be configured to access these databases for implementing the method of generating a contextual multi-armed bandit model for a personalized recommendation of a brokerage product.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

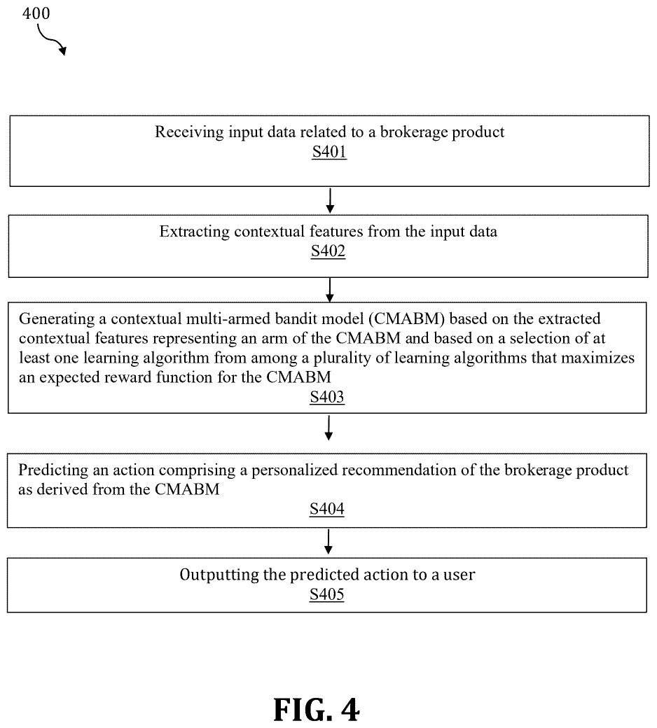

The contextual bandit RL algorithm 302 may execute a process implementing method of generating a contextual multi-armed bandit model for a personalized recommendation of a brokerage product. The process for generating a contextual multi-armed bandit model for a personalized recommendation of a brokerage product may be generally indicated at flowchart 400 in FIG. 4.

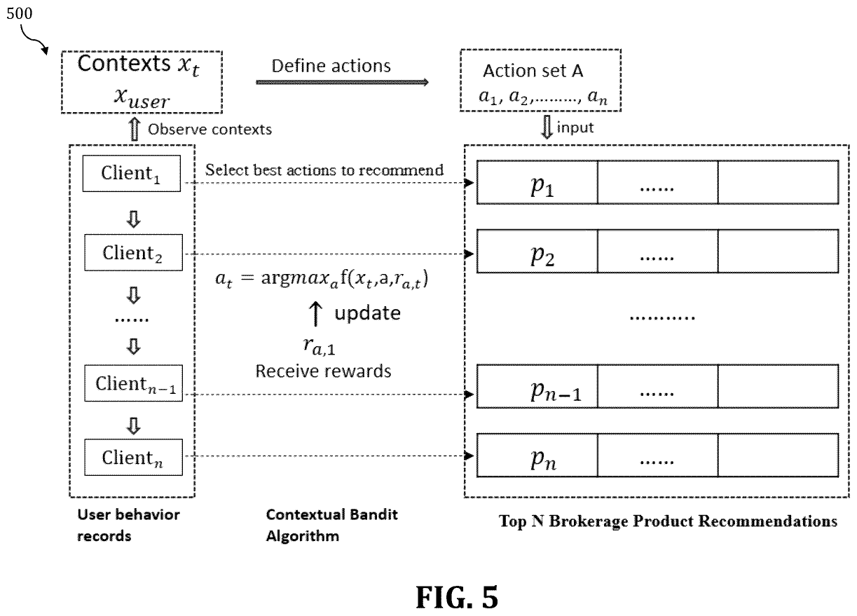

FIG. 4 illustrates a flowchart of a process diagram 400 of a process for generating a contextual multi-armed bandit model for a personalized recommendation of a brokerage product according to an embodiment. The process diagram 400 may be implemented by the system environment 300 of FIG. 3, a network environment 200 of FIG. 2, and the system 100 of FIG. 1. Further details of the various processes in FIG. 4 may be found in subsequent FIGS. 5-7.

At step S401 of the flowchart process 400, the computing apparatus 202 may receive input data related to a brokerage product. The brokerage product may be a client investment product. The input data may include a user metric and at least one from among a market trend, a product performance metric, and a historical investment data. The user metric may include a user demographic and a user identification. The historical investment data may include at least one from among a historical transaction data, a past action, and a past outcome.

At step S402 of the flowchart process 400, the computing apparatus 202 may extract contextual features from the input data. See FIG. 5 for further details. The data may be extracted by using an electronic data integration and analytics platform with data loading capabilities or by using built-in connectors.

At step S403 of the flowchart process 400, the computing apparatus 202 may generate a contextual multi-armed bandit model (CMABM or model for short) based on the extracted contextual features representing an arm of the CMABM and based on a selection of at least one learning algorithm from among a plurality of learning algorithms that maximizes an expected reward function for the CMABM. The CMABM may be any instantiation of an online or offline contextual multi-armed bandit algorithm. The CMABM may include a reinforcement learning model.

Continuing with step S403, the plurality of learning algorithms may include a linear greedy learning algorithm, a k-nearest neighbor (KNN) learning algorithm, a randomized popularity learning algorithm, a softmax learning algorithm, a Thompson sampling learning algorithm, a locality-sensitive hashing nearest neighbor (LSHNN) learning algorithm, a cluster learning algorithm, a radius neighborhood learning algorithm, and a tree bandit learning algorithm. The expected reward function may include an argmax function with an estimated reward term representing an exploitation concept and a confidence interval representing an exploration concept.

Continuing with step S403, the CMABM may be generated by training the CMABM based on the historical investment data to estimate a reward associated with the predicted action that maximizes the expected reward function. A feedback loop mechanism may also be performed as part of the training of the CMABM. The feedback loop mechanism may be based on a performance evaluation of the CMABM and at least one from among a user feedback and a changing need of a business organization that utilizes the CMABM. The performance evaluation of the CMABM may include analyzing a performance of the CMABM over a predetermined time period based on computing a suite of performance metrics such as, but not limited to: a precision metric, a recall metric, a mean average precision (MAP) metric, and a normalized discounted cumulative gain (NDCG) metric associated with the CMABM.

Continuing with step S403, the generation of the CMABM may also include updating the CMABM based on an updating rule associated with the selected at least one learning algorithm. The updating rule may include at least one from among a predetermined utility maximization rule (e.g., an upper confidence bound (UCB)), a gradient descent function, a distance measurement function, a cosine similarity function, and a probability function.

Furthermore, in conjunction the previously described processes, the generation of the CMABM may also include optimizing an epsilon-greedy algorithm based on adjusting an epsilon value to provide a balance between an exploitation concept and an exploration concept associated with the CMABM. These various processes related to step S403 are further described FIGS. 5-7.

At step S404 of the flowchart process 400, the computing apparatus 202 may include predicting an action comprising a personalized recommendation of the brokerage product as derived from the CMABM. See FIGS. 5-7 for further details. At step S405 of the flowchart process 400, the computing apparatus 202 may include outputting the predicted action to a user. For instance, the output of the predicted action may be provided to the user via a display interface.

FIG. 5 illustrates an example overview process 500 for generating a CMABM for a personalized recommendation of a brokerage product according to an embodiment as described in FIG. 4 at steps S401-S405.

The example overview process 500 (or process 500 for short) may show a CMABM (which may also be denoted as the contextual bandit algorithm). The CMABM may receive input data related to a brokerage product, which may include a data action set (e.g., action set A) and user behavior records at a plurality of time points as denoted by t associated with data item related to the user behavior. Contextual feature data (contexts xₜ) for a user x may be derived from the user behavior records for users (or clients, wherein the terms may be used interchangeably) from 1 to N, which may then be used to define user actions and derive the action set A. The CMABM may generate a prediction (p) of top N brokerage product recommendations by selecting an optimal (i.e., best) action to recommend. This may be done by generating the CMABM and implementing the model within an electronic financial platform. Doing so may offer several key benefits that can significantly enhance the platform's user experience and overall efficiency.

For instance, the CMABM may be a type of machine learning algorithm. Notably, the CMABM may be a reinforcement learning (RL) algorithm that takes into account the context feature and/or user-specific information when making decisions.

The CMABM being a contextual multi-armed bandit and thus, involves a contextual bandit problem. In a contextual bandit problem, there may be a setting where at a time step i: the CMABM may observe a random state (sometimes also called ‘query’ or ‘context’), Xᵢ. In the recommendation setting, Xᵢ can be the list of brokerage products recommended for the client. The variables, Xᵢ are assumed independent and identically distributed.

Furthermore, at the time step i, the CMABM may select an action Aᵢ for a particular client identification (ID). Here, A may be the recommendation provided to the client. Additionally, at the time step i, the CMABM may then receive a reward Ri. Here, the reward may be 1 if the recommendation is related to the brokerage product, and 0 otherwise. The reward Ri may be assumed to depend only on the context and action, Xi and Ai at the same time step.

It may be assumed at the time step i for the CMABM that there might not be dependency between the contexts (or states) at different time steps, whereas in traditional RL algorithm, the variable Xi could depend on the previous state, Xᵢ₋₁ and action, Aᵢ₋₁. In other words, the CMABM may be a simplified version of RL algorithm, where “episodes” may just be of length 1.

Continuing with FIG. 5, the CMABM may involve a policy, such as an algorithm, whereby the terms may be used interchangeably in this application. A policy π may represent a mathematical object which describes how the recommendation may be chosen when a context x is known. The policy can be either stochastic or deterministic. If deterministic, then it may be defined by a simple one-to-one mapping x→a that associates to each state x the recommended action a. More generally, the policy can be stochastic: at each possible state x, a probability distribution may be associated on the set of actions. It is thus noted that for a policy π, the term π(a, x) may denote the probability of choosing action a when in a state x.

The expected reward following a policy can be computed when training the CMABM. When training the CMABM, the goal is to find the policy which maximizes the expected reward (Ex) using an argmax function (see example argmax function below).

$$\hat{π} = Arg {max}_{π} {E}_{X} ( {E}_{A ∼ π} ( E ( R \vert A = a , X = x ) ) )$$

While the optimal policy may usually be deterministic, it may be more likely that a fully deterministic policy is not chosen because it does not account for the exploration concept. That is, in each context, an action that maximizes the expected reward may be chosen. However, a fully deterministic policy would not include consideration of the exploration concept. As such, a randomized learning algorithm can be utilized to keep some exploration on the different actions, and this is useful to learn how to improve the learning algorithm.

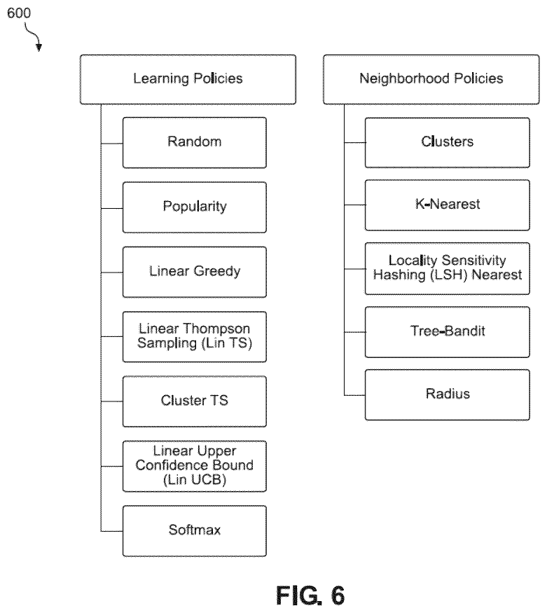

As such, the generation of the CMABM may be based on selection of at least one learning algorithm from among a plurality of learning algorithms that maximizes an expected reward function. The example learning policies are further expanded upon below in FIG. 6.

Continuing with FIG. 5, the technological advantages of the CMABM in generating the brokerage product recommendations are described below.

One advantage of the CMABM may be in providing personalized recommendations. The model is designed to make decisions based on both the action's potential reward and the context in which the decision is made. For brokerage product recommendations, this means that the model can tailor suggestions to individual clients based on their unique characteristics (e.g., investment history, risk tolerance, financial goals, etc.). This leads to a more personalized and relevant recommendations, increasing client satisfaction and engagement.

Another advantage may lie in the CMABM's efficient exploration-exploitation balance. For general recommendation systems in the status quo, it is often a challenge to balance exploration (trying out new recommendations) and exploitation (recommending what is already known to work well). The CMABM is uniquely adapted to address this challenge because the multi-armed bandit model that incorporates a selected learning algorithm can continuously learn via a feedback loop mechanism with input from client interactions, performance analysis and evaluations of the generated recommendations to optimize the operation of the CMABM and its recommendation strategy over time. This dynamic adjustment helps to improve the performance of the CMABM by dynamically adjusting its operations (e.g., adjusting which algorithm is selected) to changing data inputs (e.g., changing contextual features, changing client data, changing market trends, etc.) to quickly identify and generate a recommendation of the best-performing brokerage products that is personalized to the individual client's needs.

Related to the above advantage, another advantage is adaptability to changing preferences. Client investment preferences can change due to various factors like market conditions, life events, or evolving financial knowledge, etc. The CMABM can adapt to these changes by continuously learning from the contextual data, ensuring that the recommendations remain relevant over time. This adaptability is important in the financial domain for managing client assets and wealth, where market conditions and client behaviors are highly dynamic.

Another advantage of the CMABM may be in a reduced need for extensive historical data. Unlike traditional machine learning models that require extensive historical data for training, the CMABM can start making effective recommendations with relatively less data. This is particularly beneficial in brokerage settings, where client preferences might not be well-documented initially, or when launching new products for which historical performance data is limited.

Another advantage of the CMABM may be real-time learning and decision making. The CMABM is well-suited for real-time applications because it can update its strategy based on new data immediately as it becomes available. This real-time learning capability is advantageous in brokerage product recommendations, where timely and relevant suggestions can significantly impact client decision-making and investment outcomes.

Another advantage of the CMABM may be in handling multi-armed scenarios because brokerage product recommendations often involve multiple products (or “arms”) to recommend, each with its own risk-return profile. As such, the CMABM is a unique model that can efficiently manage these multi-armed scenarios, ensuring that the CMABM considers all available products and recommends those that are most likely to meet the client's needs based on their context.

Another advantage of the CMABM may be in an improved customer retention and satisfaction. By providing more accurate and personalized recommendations, the CMABM can enhance the overall client experience. Satisfied client are more likely to continue using the business organization's investment platform, leading to higher retention rates and increased lifetime value for the business organization.

Another advantage of the CMABM may be in regulatory compliance and risk management. In the financial industry, it is important to recommend products that align with the client's risk profile and regulatory requirements. The CMABM can be designed to incorporate these constraints into the recommendation process, ensuring that the recommendations are not only profitable but also compliant with regulations and appropriate for the client's risk tolerance. In summary, the use of the CMABM for brokerage product recommendations leverages the ability to personalize suggestions dynamically, adapt to changing client preferences, and make real-time decisions, all while efficiently managing exploration and exploitation concepts. These advantages make the CMABM a powerful machine learning model for enhancing user experience and business outcomes in the financial sectors, especially the financial sectors that handle managing wealth of high-net-worth individuals.

Continuing with FIG. 5, the CMABM can receive inputs that may include training data, testing data, cross-validation data, user features data frame data, envelope data, columns to encode data, batch size, verbose command, decisions data, rewards data and context data. The training data may be used to train the CMABM and should include a row for each training sample. The testing data may generate recommendations and the data should have a row for each testing sample.

The cross-validation data may include a number of folds in the training data to use for cross-fold validation. A grouped K-fold iterator may be used to ensure that the same envelope identifier is not contained in different folds. When using cross-validation, the test data must be “none”. The user features data frame data may include user features for each envelope identifier, wherein each row of data should include the envelope identifier and a list of user features.

The envelope data may include a list of envelope features such as risk profile score, annual income, current federal income tax bracket, etc. and can be a subset of the total features. If the envelope data is listed as “none”, then all the features are presently used. Outliers in the envelope data may be excluded from the dataset by data extraction.

The columns to encode data may map each user feature datapoint to a valid data encoding. The batch size may be used to chunk data into batch sizes. The verbose command may include a Boolean command and a setting wherein default=false. The verbose command may also include a command for whether to print progress status or not. The decisions data may include a list of decisions being made. The rewards data may include rewards received corresponding to the decisions. The contexts data may include a context under which each decision is made.

Transforming categorical features into dummy variables can be particularly helpful for certain learning algorithms in the CMABM, such as the epsilon-greedy algorithm, Thompson sampling algorithm, or linear upper confidence bound policies. These algorithms can efficiently handle the high-dimensional feature space created by dummy variables.

In the case of neighborhood policies, the transformation allows for straightforward computation of similarity metrics, as each feature is represented as a binary vector. This facilitates clustering or nearest-neighbor approaches to identify similar contexts. The potential sparsity and high dimensionality of the resulting feature space should be properly managed in order to not negatively impact the CMABM's performance and computational efficiency. Therefore, regularization techniques may be implemented to optimize the CMABM's performance.

For missing or incomplete data values, then data defaults may serve as fallback values for missing or incomplete data. Thus, allowing the CMABM to function smoothly without interruptions. For instance, if a client's risk tolerance score is unavailable, a default value based on a median value of average risk profiles that might be used to maintain continuity in recommendations.

Similarly, input ranges may define the acceptable boundaries for each variable, ensuring that the data being fed into the CMABM is within a realistic and meaningful spectrum. For example, financial metrics such as annual income, net worth, and investment knowledge should fall within predefined ranges of minimum and maximum values of each feature that reflect typical client scenarios. These ranges help prevent the CMABM from being skewed by outliers or erroneous data entries, which could lead to inaccurate recommendations. By carefully defining data defaults and input ranges, the CMABM can better handle variability in the data, maintain robustness against anomalies, and deliver consistent, personalized recommendations. This approach not only enhances the CMABM's reliability but also ensures that it remains aligned with the practical realities of client interactions and market dynamics.

Converting categorical features to numerical features in the context of the CMABM may involve a process that can enhance data confidentiality while maintaining the utility of client investment and wealth data. This transformation is typically achieved through techniques such as one-hot encoding, label encoding, or embedding methods, which convert categorical data into a numerical format that can be effectively utilized by machine learning algorithms. By converting sensitive categorical information, such as client risk profiles, investment preferences, or account types, into numerical representations, the data becomes less directly interpretable, adding an additional layer of abstraction that can help protect client identities and sensitive attributes.

The adequacy of upstream data/application linkages and the appropriateness of inputs derived from these linkages may be crucial for the successful operation of the CMABM. Live data may provide a dynamic and real-time context that allows for the continuous assessment of how well the CMABM operates in conjunction with other applications upstream, such as but not limited to client profiling systems and market trend analyzers. An evaluation of these upstream applications may be performed since they may generate relevant inputs for the CMABM. With live data, it may become possible to monitor the accuracy and timeliness of the information flowing from these upstream applications, ensuring that the properly reflect current client behaviors and market conditions.

This real-time feedback loop can enable the identification of any discrepancies or lags in data transmission, allowing for prompt adjustments to maintain the integrity and relevance of the inputs. Furthermore, live data facilitates the validation of assumptions made by upstream applications, such as the stability of client risk profiles or the persistence of market trends, ensuring that these assumptions hold true in practice. By leveraging live data, the CMABM can be fine-tuned to ensure that upstream linkages are robust, and the inputs are relevant and proper, ultimately enhancing the CMABM's ability to deliver accurate and personalized recommendations that meet the evolving needs of clients.

Indeed, the quality and completeness of the input data is important for the CMABM because the CMABM requires comprehensive and accurate client investment and wealth data, including financial profiles, risk tolerance, and investment preferences, to function optimally. Incomplete or outdated data can lead to sub-optimal recommendations.

Additionally, the CMABM assumes that the input parameters are within a reasonable range of values that reflect typical client scenarios because extreme or anomalous values may skew the results. The CMABM may also rely on the assumption that historical data patterns are indicative of future trends, which may or may not be valid depending on the volatility of the market.

Furthermore, the CMABM's performance may be contingent on the proper encoding and transformation of categorical variables into numerical formats, as improper handling can lead to loss of information or misinterpretation. While the CMABM may be designed to be robust and adaptable, these boundaries highlight the importance of maintaining high-quality data inputs and continuously monitoring the CMABM's outputs to ensure the CMABM's ongoing effectiveness in providing personalized brokerage product recommendations.

FIG. 6 illustrates example 600 learning algorithms (which can also be used interchangeably with the term algorithms) for utilization in the CMABM according to an embodiment as described in FIG. 4 at steps S403-S405. That is, the example 600 is illustrating various policies/algorithms. The example policies may include various algorithms including learning algorithms and neighborhood-type learning algorithms. The learning algorithms may include, but are not limited to: random, popularity, linear greedy, linear Thompson sampling, cluster Thompson sampling, linear upper confidence bound, and softmax. The neighborhood-type learning algorithms may include, but are not limited to: clusters, K-nearest neighbor (KNN), locality sensitivity hashing nearest, tree-bandit, and radius.

The CMABM is a multi-armed bandit model, which may involve reinforcement learning. In general, an arm may be an idea or strategy. A bandit may be a group of arms or strategies representing potential actions. In the present application, the arms or strategies are related to recommending a brokerage product. In general, a “pull” or play or trial may represent a chance to test the idea or strategy. In general, the reward may represent a unit of success that is measured after each “pull” or play or trial. In general, the regret may represent a performance metric.

The random and popularity algorithms may be denoted as a randomized popularity learning algorithm. This algorithm may return a randomized popular arm for each prediction/recommendation. The terms prediction or recommendation may be used interchangeably since they are denoting predicting a recommendation of a brokerage product. The probability of selection for each arm may be weighted by its mean reward. An assumption may be made that the rewards are non-negative.

In a popularity-based algorithm, the goal is to select the arm (or action) that is most popular, i.e., the one with the highest expected reward or utility. The probability of selecting arm aₜ may be calculated as shown below, wherein μᵢ is the mean reward (or popularity) for that arm i.

$$P ( {a}_{t} ) = \frac{{μ}_{{a}_{t}}}{{\sum }_{i = 1}^{N} {μ}_{i}}$$

The objective function for the popularity-based selection is defined as:

$$a = arg {\underbrace{max}}_{{a}_{t}} {μ}_{{a}_{t}} .$$

The term aₜ denotes the arm being selected at time t. The term μₐ_{ₜ} represents the expected reward (or popularity) of arm aₜ. The arm with the highest μₐ_{ₜ} is selected.

In a random algorithm, the selection of an arm is probabilistic, and the probability of selecting an arm is proportional to its expected reward μᵢ. The objective function can be represented as shown below.

$$a = arg {\underbrace{max}}_{{a}_{t}} ( \frac{{μ}_{{a}_{t}}}{{\sum }_{i = 1}^{N} {μ}_{i}} )$$

The term

$${\sum }_{i = 1}^{N} {μ}_{i}$$

denotes the sum of expected rewards of all arms.

The linear upper confidence bound (LinUCB) algorithm may balance exploration concept and exploitation concept of the CMABM by enabling a selection of an action (e.g., recommendation of brokerage product) with the highest estimated reward (e.g., click-through rate) based on linear models. In each round, the context vector x_{a,t} of each arm a∈ [symbol] at time t of the CMABM may be observed. An arm of the CMABM may be selected. Then, a corresponding reward r_{a,t} is modeled as a linear function of the context vector x_{a,t} (denoting a feature vector associated with action a at time t). The term

$${r}_{a , t} = {θ}_{a}^{T} {x}_{a , t} ,$$

wherein θₐ is the parameter vector for action a.

The CMABM may then be updated based on the selected. The term Cₜ(a) may represent a confidence interval associated with exploration concept. The confidence interval Cₜ(a) may be derived from the uncertainty in the estimate of θₐ. It is typically proportional to the standard deviation of the estimate. The term [symbol] may represent an estimated reward associated with exploitation concept. The combined terms [symbol] +Cₜ(a) may represent an upper confidence bound.

$${a}_{t} = {argmax}_{a} ( {\hat{r}}_{a , t} + {C}_{t} ( a ) )$$

Continuing with the LinUCB algorithm, the confidence interval is denoted by

$${C}_{t} ( a ) = α \sqrt{{x}_{a , t}^{T} {A}_{a}^{- 1} {x}_{a , t}} .$$

The term Aₐ is a matrix that accumulates information about action a and is updated as

$${A}_{a} = {A}_{a} + {x}_{a , t}^{T} {x}_{a , t} .$$

A hyperparameter (α) controls the exploration-exploitation trade-off and is typically chosen based on the desired confidence level. The LinUCB algorithm may select the action aₜ at time t by maximizing the sum of the estimated reward and confidence interval as shown below.

$${a}_{t} = {argmax}_{a} ( {\underbrace{{θ}_{a}^{T} {x}_{a , t}}}_{Exploitation} + {\underbrace{α \sqrt{{x}_{a , t}^{T} {A}_{a}^{- 1} {x}_{a , t}}}}_{Exploration} )$$

The exploitation term represents the estimated reward based on the current model. The exploration term represents the uncertainty in the estimate, encouraging exploration of less-known actions.

The softmax learning algorithm may select each arm with a probability proportionate to its average reward. The softmax learning algorithm provides a balance between exploration and exploitation by assigning probabilities to actions based on their estimated rewards, with a temperature parameter τ controlling the level of exploration. The average reward may be calculated as a logistic function with each probability as shown below, wherein μᵢ may be the mean reward for that arm and τ may be the “temperature” to determine the degree of exploration. The probability of selecting an arm i is given by a distribution function of the softmax learning algorithm as shown below.

$$P ( a = i ) = \frac{{e}^{( {μ}_{i} - max μ )} / τ}{{Σ}_{j = 1}^{N} {e}^{( {μ}_{j} - max μ )} / τ}$$

When τ→0, the softmax learning algorithm becomes greedy (pure exploitation). When τ→∞, the softmax learning algorithm becomes purely exploratory (uniform selection).

To incorporate a confidence interval into the softmax learning algorithm, the estimated reward μᵢ can be modified to include an exploration bonus based on uncertainty. This is similar to the upper confidence bound (UCB) approach. With this approach, the confidence interval is denoted by

$${C}_{t} ( i ) = α \sqrt{\frac{log t}{{n}_{i}}} ,$$

wherein t is the number of rounds so far, nᵢ is the number of times arm i has been selected, and a is a hyperparameter controlling the exploration-exploitation trade-off. The softmax learning algorithm may select an arm aₜ at time t as shown below.

$${a}_{t} = {argmax}_{i} ( \frac{{e}^{( {μ}_{i} - max μ )} / τ}{{Σ}_{j = 1}^{N} {e}^{( {μ}_{j} - max μ )} / τ} )$$

The term μᵢ= [symbol] +Cₜ(i) is the modified reward estimate for arm i. The term [symbol] be the empirical mean reward for arm i. The term max μ=maxⱼ μⱼ is the maximum modified reward estimate among all arms.

The softmax learning algorithm with a confidence interval can then be formulated as shown below.

$${a}_{t} = {argmax}_{i} ( \frac{{e}^{( \text{?} + α \sqrt{\frac{log t}{{n}_{j}}} - maxμ )} / τ}{{Σ}_{j = 1}^{N} {e}^{( \text{?} + α \sqrt{\frac{log t}{{n}_{j}}} - maxμ )} / τ} )$$

The exploitation concept may be represented by the term [symbol] , which encourages selecting arms with high empirical rewards. The exploration concept may be represented by the term

$$α \sqrt{\frac{log t}{{n}_{i}}} ,$$

which encourages exploring arms with high uncertainty (i.e., fewer pulls). The temperature t controls the balance between exploration and exploitation.

The Thompson sampling learning algorithm may create a beta distribution for each arm, and then randomly samples from these distributions. The arm with the highest sample value may be selected (as shown below). Note that rewards must be binary to create beta distributions. Hence, the initial rewards are 0 and 1. The term Γ is the gamma function, which may be a generalization of the factorial function. The terms α and β are shape parameters. The term μᵢ is the mean reward for arm, i. The term P(arm) is a power function of the variable, μᵢ, and of its reflection, (1−μᵢ)

$$P ( arm ) = \frac{Γ ( {α}_{i} + {β}_{i} )}{Γ ( {α}_{i} ) Γ ( {β}_{i} )} {{μ}_{i}^{{α}_{i} - 1} ( 1 - {μ}_{i} )}^{{β}_{i} - 1}$$

The term μᵢ is the probability of success for arm i. The terms αᵢ and βᵢ are the parameters of the Beta distribution for arm i. The parameters αᵢ and βᵢ are updated based on observed rewards. The term αᵢ is incremented by 1 for each success whereas βᵢ is incremented by 1 for each failure.

At each time step t, the Thompson sampling learning algorithm performs the various steps as described below. A first step may be to sample a reward probability μᵢ from the Beta distribution for each arm i: μᵢ~Beta(αᵢ, βᵢ). A second step may be to select the arm with the highest sampled reward probability: aₜ=argmaxᵢ μᵢ. A third step may be to observe the reward (e.g., 0 or 1 for binary rewards). A fourth step may be to update the parameters αᵢ and βᵢ for the selected arm as shown below:

$$If {r}_{t} = 1 : {α}_{i} ← {α}_{i} + 1.$$

$$If {r}_{t} = 0 : {β}_{i} ← {β}_{i} + 1$$

To incorporate a confidence interval into the Thompson sampling learning algorithm, the sampling step can be modified to include an exploration bonus based on the uncertainty in the estimate of μᵢ. The uncertainty is captured by the variance of the Beta distribution as shown below.

$$V a r ( {μ}_{i} ) = \frac{{α}_{i} {β}_{i}}{{( {α}_{i} + {β}_{i} )}^{2} ( {α}_{i} + {β}_{i} + 1 )}$$

Continuing with the Thompson sampling learning algorithm, the confidence interval for μᵢ can be approximated using the standard deviation of the Beta distribution: Cₜ(i)=α\sqrt{Var(μᵢ)}. The term α is a hyperparameter for controlling the exploration-exploitation trade-off. The modified sampling step then becomes: μᵢ~Beta(αᵢ, βᵢ)+Cₜ(i).

The Thompson sampling learning algorithm with a confidence interval can be formulated as shown below.

$${a}_{t} = {argmax}_{i} ( {μ}_{i} + α \sqrt{\frac{{α}_{i} {β}_{i}}{{( {α}_{i} + {β}_{i} )}^{2} ( {α}_{i} + {β}_{i} + 1 )}} )$$

The term μᵢ~Beta(αᵢ, βᵢ) is sampled from the Beta distribution. The term

$${C}_{t} ( i ) = α \sqrt{\frac{{α}_{i} {β}_{i}}{{( {α}_{i} + {β}_{i} )}^{2} ( {α}_{i} + {β}_{i} + 1 )}}$$

is the confidence interval.

The Thompson sampling learning algorithm with a Beta distribution and a confidence interval can then be summarized as: (1) initializing the term αᵢ, βᵢ for each arm i. Then (2) at each time step, performing a sampling process for each arm i, computing a confidence interval, selecting an arm, observing a reward rt, and updating the term αᵢ, βᵢ for the selected arm based on rₜ. The sampling process involves sampling μᵢ~Beta(αᵢ, βᵢ) for each arm i. Computing the confidence interval involves computing the confidence interval

$${C}_{t} ( i ) = α \sqrt{\frac{{α}_{i} {β}_{i}}{{( {α}_{i} + {β}_{i} )}^{2} ( {α}_{i} + {β}_{i} + 1 )}} .$$

Selecting an arm involves computing:

$${a}_{t} = arg {max}_{i} ( {μ}_{i} + α \sqrt{\frac{{α}_{i} {β}_{i}}{{( {α}_{i} + {β}_{i} )}^{2} ( {α}_{i} + {β}_{i} + 1 )}} ) .$$

Turning now to the neighborhood-type learning algorithms. As previously noted, the terms learning algorithm and algorithm may be used interchangeably in this application. The locality-sensitive hashing nearest neighbors (LSHNN) algorithm may be a nearest neighbor approach that uses locality sensitive hashing function, h, with a simhash to select observations to be used with a learning algorithm. The similarity, sim(x, y) of two points (contexts), x and y, may be the cosine of the angle between them. That is, the cosine distance may be represented as sim(x, y)=cos θ_{x,y}, wherein θ_{x,y} is the angle between x and y. The LSHNN algorithm may be shown below with the simhash function, ensuring that the probability of collision (i.e., (P[h(x)=h(y)])) satisfies the conditions of c<1 and p2<p1. P[h(x)=h(y)]≥p1 if sim(x,y)≥S₀ and P[h(x)=h(y)]≤p2 if sim(x, y)≤eS₀ The term S₀ is a similarity threshold. The terms p₁ and p₂ are probabilities such that p₂<p₁ and

$$c = \frac{log {p}_{1}}{log {p}_{2}} < 1.$$

The simhash function maps a high-dimensional vector, x to a binary hash value h(x).

The simhash function maps a high-dimensional vector x to a binary hash value h(x). The mapping steps include: (1) generating a random hyperplane r (i.e., a random vector with the same dimensionality as x), and (2) computing the hash value h(x)=sign(r^{T}x). If r^{T}x≥0, then h(x)=1 and 0 otherwise. This objective function selects the observation y that maximizes the similarity to x among those that collide with x in the hash space.

Continuing with the LSHNN algorithm, the concept of close together may be within the context of the similarity metric. In this case, recommendations may be considered as close together when the angle between them the two points x and y representing the two recommendations of brokerage products are small. The smaller the angle between the two points, the closer the two recommendations are to each other. Hence, contexts that are close together will have, with high probability, the same value. Conversely, contexts that are far apart will have a different value.

Continuing with the LSHNN algorithm, for the simhash, this may be achieved by dividing the space with hyperplanes. Contexts may be projected as points onto a hyperplane of n_{contexts}_{_{cols}}×n_{dimensions} and each column of the hyperplane may be evaluated for its sign, giving an ordered array of binary values. This may then be converted to a base 10 integer used as the hash code to assign the context to a hash table. This process may be repeated for a specified number of hash tables, wherein each has a unique, randomly-generated hyperplane. To select the neighbors for a context, the hash code may be calculated for each hash table and any contexts with the same hashes are selected as the neighbors.

To ensure the LSHNN properties, we k independent simhash functions may be utilized and their outputs concatenated to form a composite hash value. This may be achieved by several steps. First, generating k random hyperplanes r₁, r₂ . . . , rₖ. Second, computing the hash value for each vector x: h(x)=[h₁(x), h₂(x), . . . , hₖ(x)], wherein

$${h}_{i} ( x ) = sign ( {r}_{i}^{T} x ) .$$

Third, defining the similarity condition:

$$If f sim ( x , y ) \geq {S}_{0} , then P [ h ( x ) = h ( y ) ] \geq {p}_{1} .$$

$$If sim ( x , y ) \leq {S}_{0} , then P [ h ( x ) = h ( y ) ] \geq {p}_{2} .$$

As with the radius or k value for other nearest neighbors algorithms, selecting the best number of dimensions and tables requires tuning. For the dimensions, a good starting point may be to use the log of the square root of the number of rows in the training data. This will give sqrt(n_rows) number of hashes. The probability of collision P[h(x)=h(y)] for the simhash may be:

$$P [ h ( x ) = h ( y ) ] = {( 1 - \frac{{θ}_{x , y}}{π} )}^{k} .$$

The LSHNN conditions may be satisfied based on the equations shown below.

$$If sim ( x , y ) \geq {S}_{0} , then {( 1 - \frac{{θ}_{x , y}}{π} )}^{k} \geq {p}_{1} .$$

$$If sim ( x , y ) \leq {S}_{0} , then {( 1 - \frac{{θ}_{x , y}}{π} )}^{k} \geq {p}_{2} .$$

The parameters k, p₁, p₂ are chosen such that

$$c = \frac{log {p}_{1}}{log {p}_{2}} < 1.$$

The number of dimensions and number of tables have inverse effects from each other on the number of empty neighborhoods and average neighborhood size. Increasing the dimensionality decreases the number of collisions, which increases the precision of the approximate neighborhood but also potentially increases the number of empty neighborhoods. Increasing the number of hash tables increases the likelihood of capturing neighbors the other random hyperplanes miss and increases the average neighborhood size. It should be noted that the fit operation is O(2**n_dimensions).

The fit operation may include: (1) generating k random hyperplanes r₁, r₂ . . . , rₖ. The fit operation may also include: (2) computing the hash value for each vector x: h(x)=[h₁(x), h₂(x), . . . , hₖ(x)] for each vector x. The fit operation may also include: (3) selecting observations using the objective function:

$$a = arg {max}_{y} ( sim ( x , y ) \cdot I [ h ( x ) = h ( y ) ] ) .$$

The tree bandit algorithm may fit a decision tree for each arm using context history. It uses the leaves of these trees to partition the context space into regions and keeps a list of rewards for each leaf. To make a prediction, the tree bandit algorithm may receive a context vector and go to the corresponding leaf at each arm's tree and apply the given context-free multi-armed bandit (MAB) learning policy to predict expectations and choose an arm. The tree bandit neighborhood algorithm may be compatible with the following context-free learning algorithm only: epsilon greedy, Thompson sampling, and upper confidence bound interval.

To implement a tree bandit algorithm wherein each arm utilizes a decision tree trained on its context history, the contextual bandit framework can be combined with decision trees for reward prediction and incorporate exploration through an upper confidence bound (UCB) approach in one of the scenarios.

The algorithm for implementing the tree bandit algorithm (e.g., UCB with decision trees may involve various steps as recited in Table 1.

TABLE 1
Algorithm for implementing the tree bandit algorithm.

```
Initialization: For each arm a:
  Initialize an empty dataset Dₐ to store context-reward pairs.
  Initialize a decision tree Tₐ (initially empty).
  Track total pulls Nₐ = 0.
Parameters:
  Exploration constant c ≥ 0.
  Re-training frequency (e.g., re-train after every K new samples).
Algorithm:
For each round (t = 1, 2, . . . ):
  1. Receive Context: Observe context xₜ.
  2. Compute Scores: - For each arm a:
    Predict: Route xₜ through Tₐ to reach leaf Lₐ.
    Leaf Statistics: Retrieve mean reward (μₐ) and count (nₐ) from Lₐ.
    If Lₐ is new, use default values (e.g., μₐ = 0, nₐ = 0).
    $- UCB Score : {Score}_{a} = {μ}_{a} + c \sqrt{\frac{ln ( t + 1 )}{{n}_{a} + 1}} .$
  3. Select Arm: Choose arm:
      ${a}_{t} = arg {max}_{a} ( {μ}_{a} + c \sqrt{\frac{ln ( t + 1 )}{{n}_{a} + 1}} )$
  4. Observe Reward: Receive reward rₜ after playing aₜ.
  5. Update Data: Append (xₜ, rₜ) to Dar. Increment Nₐ_{ₜ}.
  6. Retrain Trees: If retraining frequency K = 0, retrain Tₐ_{ₜ} on Dₐ_{ₜ}.
```

The tree bandit algorithm may be a neighborhood-type learning algorithms that may be a modified version of the tree heuristic algorithm which uses decision tree learners to model the context-reward distribution for each action. To navigate the exploration-exploitation tradeoff, a parameter free bootstrapping technique that emulates the core principle behind Thompson sampling may be utilized as part of the tree bandit algorithm.

The radius (i.e., radius nearest neighbors RNN) algorithm may be a nearest neighborhood approach that selects the observations within a given radius to be used with a learning policy. The RNN algorithm is a variation of the KNN algorithm, whereby instead of selecting a fixed number of neighbors k, all neighbors within a given radius r may be selected. This approach can be particularly useful when the density of data points varies significantly across the feature space.

The mathematical formulation of the RNN algorithm is described below. The goal is to select an action aₜ at time t that maximizes the expected reward given a context xₜ by considering observations within a given radius r from the current context. This approach leverages the similarity between the current context and historical data to make decisions.

Continuing with the RNN algorithm, the neighborhood N(xₜ, r) of the current context xₜ is defined as: N(xₜ, r)={xᵢ, aᵢ, rᵢ)∈D|∥xₜ−xᵢ∥≤r}, wherein historical data,

$$D = {\{ ( {x}_{i} , {a}_{i} , {r}_{i} ) \}}_{i = 1}^{n}$$

is the set of past observations and ∥xₜ−xᵢ∥ is the Euclidean distance between xₜ and xᵢ.

Continuing with the RNN algorithm, for each action a, the average reward of all observations in the neighborhood N(xₜ, r) is computed as shown below where action a was taken.

$$\text{?} ( a ) = \frac{1}{\vert {N}_{a} ( {x}_{t} , r ) \vert} {\sum }_{( {x}_{i} , {a}_{i} , {r}_{i} ) ∈ {N}_{a} ( {x}_{t} , r )} {r}_{i}$$

The term Nₐ(xₜ, r)={(xᵢ, aᵢ, rᵢ)∈Nₐ(xₜ, r)|aᵢ=a} is the subset of the neighborhood where action a was taken, and |Nₐ(xₜ, r)| is the number of such observations.

For the objective function, action aₜ is selected as the one that maximizes the estimated reward:

$${a}_{t} = arg {max}_{a} ( \frac{1}{\vert {N}_{a} ( {x}_{t} , r ) \vert} {\sum }_{( {x}_{i} , {a}_{i} , {r}_{i} ) ∈ {N}_{a} ( {x}_{t} , r )} {r}_{i} ) .$$

Furthermore, the term Nₐ(xₜ, r)={xᵢ, aᵢ, rᵢ)∈D|∥xₜ−xᵢ∥≤r, aᵢ=a}.

The clusters neighborhood algorithm may be a k-means clustering approach that uses the observations from the closest cluster with a learning policy. The idea is to identify clusters of similar contexts and use the rewards from these clusters to estimate the expected reward for each action. The action aₜ is then chosen to maximize the expected reward based on the cluster to which the current context xₜ belongs. The clusters neighborhood algorithm for the nearest neighborhood approach in a contextual bandit setting can be summarized as shown below.

$${a}_{t} = arg {max}_{a} ( \frac{1}{\vert {C}_{a} ( {x}_{t} ) \vert} {\sum }_{( {x}_{i} , {a}_{i} , {r}_{i} ) ∈ {C}_{a} ( {x}_{t} )} {r}_{i} )$$

The clusters neighborhood algorithm may be subjected to Cₐ(xₜ, r)={(xᵢ, aᵢ, rᵢ)∈C(xₜ)|aᵢ=a}, which is the subset of the cluster where action a was taken, and |Cₐ(xₜ)|, which is the number of such observations.

The KNN algorithm may be a nearest neighbors approach that selects the k-nearest observations to be used with a learning policy. The KNN algorithm selects the k nearest observations to the current context xₜ. The action aₜ is then chosen to maximize the expected reward based on these k nearest neighbors. The objective function of the KNN algorithm for the nearest neighborhood approach in a contextual bandit setting can be summarized as shown below, and is similar to the clusters neighborhood algorithm.

$${a}_{t} = arg {max}_{a} ( \frac{1}{\vert {N}_{k , a} ( {x}_{t} ) \vert} {\sum }_{( {x}_{i} , {a}_{i} , {r}_{i} ) ∈ {N}_{k , a} ( {x}_{t} )} {r}_{i} )$$

The KNN algorithm may be subject to N_{k,a}(xₜ)={xᵢ, aᵢ, rᵢ)∈Nₖ(xₜ)|aᵢ=a}, which is the subset of the k-nearest neighbors where action a was taken, and N_{k,a}(xₜ), which is the number of such observations. The KNN algorithm may also be subject to Nₖ(xₜ)={(xᵢ, aᵢ, rᵢ)∈D|(xᵢ, aᵢ, rᵢ) are the k nearest neighbors to xₜ}.

The various algorithm may be considered for incorporation into the CMABM because they may be designed to balance exploration concept and exploitation concept, which are crucial components in reinforcement learning aspect of the CMABM. Referring again to FIG. 6, among these algorithms, greedy type algorithms (e.g., linear greedy), Thompson sampling type algorithms (e.g., linear Thompson sampling, cluster Thompson sampling, etc.), tree bandit algorithm, and softmax algorithm may be highlighted, since they encompass both context-free and contextual algorithms. Context-free algorithms, such as traditional Thompson Sampling, do not consider additional information about the environment, while contextual algorithms, such as linear greedy, can leverage contextual information to make more informed decisions.

In an example, the cluster algorithm may ultimately be selected as the algorithm for incorporation in the CMABM, with popularity and random algorithms serving as benchmarks for comparison. The choice of the cluster algorithm is because it may suggest a focus on leveraging the inherent structure within the data by grouping similar contexts or entities, which can enhance decision-making by tailoring actions to specific clusters. This approach can provide a balance between complexity and interpretability, making it suitable for the problem of making brokerage product recommendations.

The popularity algorithm, often used as a benchmark, may typically recommend actions based on their overall popularity or frequency, providing a straight-forward baseline that does not account for individual context. The random algorithm, another common benchmark, may select actions randomly, offering a baseline that highlights the value of more informed strategies.

By comparing the cluster algorithm against these benchmarks, it may be demonstrated that the effectiveness of the chosen algorithm for incorporation into the CMABM can result in improving the CMABM's performance over simpler, less context-aware approaches. This comparison can help to validate the cluster algorithm's ability to better balance exploration and exploitation, ultimately leading to more effective decision-making in the given context of brokerage product recommendations.

Additionally, the present approach also mentions several other algorithms, including KNN, LSHNN, and cluster Thompson sampling, which may represent both dynamic and static approaches to action selection. Dynamic approaches can adaptively change their strategies based on new data, while static approaches rely on predefined rules or structures.

Additionally, benchmarks for the algorithms may also be utilized as part of the generation of the CMABM. Benchmark library may be used in the software code for generating the CMABM that may include training, scoring, and evaluating each learning algorithm using cross-validation benchmarks with manifolds for the cross-validation from the training data. Otherwise, the CMABM may train on the training data and evaluate on the testing data. The algorithms (which may be represented in the evaluation as a value) may be benchmarked using dictionary with names (i.e., keys).

Furthermore, in the context of the algorithms mentioned (e.g., cluster Thompson sampling, clusters, KNN, tree-bandit, softmax, and LSHNN), a fine-tuning of the CMABM can be performed. Regularization schemes such as L2 regularization, dropout, early stopping, and/or pruning may play a crucial role in managing the CMABM's complexity while enhancing its generalization.

For the cluster Thompson sampling and clusters algorithms, which involve clustering, regularization might not be directly applicable in the traditional sense, but controlling the number of clusters and ensuring distinct separation may act as a form of regularization by preventing overfitting to specific data patterns. In KNN, while L2 regularization might not directly be used, selecting an appropriate number of neighbors (k) and employing feature scaling can simplify the decision boundary.

The tree bandit algorithm may also benefit from regularization techniques like pruning, which involves removing parts of the tree that do not to provide significant power in predicting target variables and thus, preventing overfitting. For the softmax algorithm, while traditional regularization like L2 might not be directly applicable, adjusting the temperature parameter, which may be represented as τ, may help to maintain a balance between exploration and exploitation concepts, ensuring stable action probabilities. In LSHNN algorithm, regularization may be more about parameter tuning, wherein the choice of L1 and L2 may relate to controlling the number of hash tables and hash functions, respectively. Thus, influencing the trade-off between search accuracy and computational efficiency. Overall, while some of these algorithms do not use regularization in the conventional sense, the principles of managing complexity and ensuring robust generalization are integral to their effective implementation.

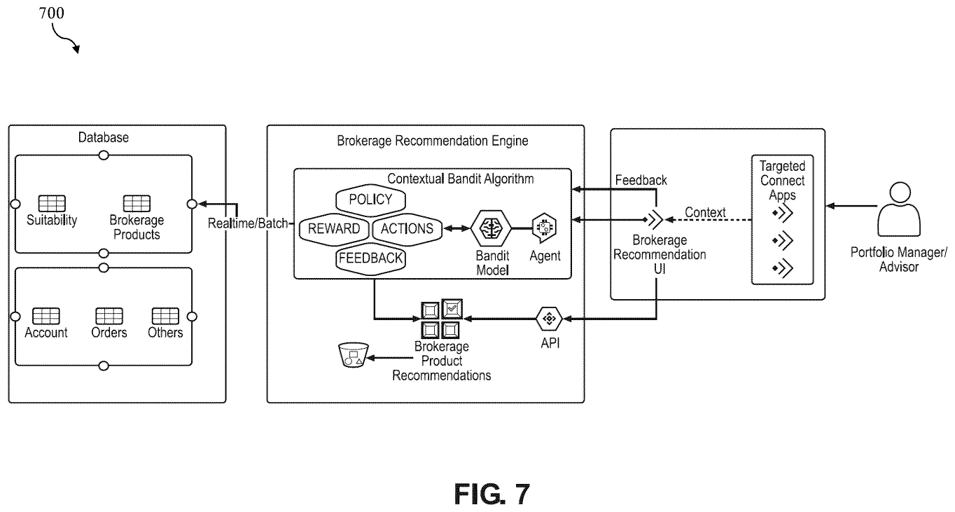

FIG. 7 illustrates an example detailed system operational framework 700 for generating a CMABM for a personalized recommendation of a brokerage product according to an embodiment as described in FIG. 4 at steps S401-S405. In the example detailed system operational framework 700, a digital data source platform may be utilized to provide real-time data to the CMABM. For example, the digital data source platform may include the real-time data to the brokerage recommendation engine (which comprises the CMABM). The digital data source platform data may represent the input data. The database may include historical datasets that may comprise, but are not limited to, account data, order data, and other data. The other data can include any other relevant data, e.g., a market trend, a product performance metric, or a historical investment data. The historical investment data may include at least one from among a historical transaction data, a past action, and a past outcome. Essentially, these datasets may be a variety of relevant data and contexts to the CMABM for the CMABM to make a recommendation of the brokerage product. Thus, the digital data source platform datasets may include input data comprising a user metric such as a user demographic and a user identification.

The database may also ensure that only suitable (i.e., relevant) data are being provided to the CMABM via the brokerage recommendation engine and that this relevant data relate to a brokerage product. An example of ensuring the data being provided are suitable may include standardizing or normalizing the data such that it is in a format easily ingestible for utilization by the CMABM.

Sourcing data from a database that includes client investment and wealth data can significantly enhance the CMABM's effectiveness and personalization capabilities. By incorporating client suitability data (i.e., investment and wealth data), the CMABM may gain access to rich insights into individual client profiles, accounts, orders, and other client data (e.g., preferences, risk tolerances, and investment goals). The decentralized nature of a database also facilitates the integration of diverse data sources (e.g., market trends, product performance metrics, and historical client interactions, etc.), providing a comprehensive view that can inform more nuanced and accurate financial product recommendations.

This approach may enable the integration of detailed client profiles, including their knowledge of variable annuities, structured products, stocks, over-the-counter derivatives, money markets, mutual funds, fixed income, etc. By capturing these specific knowledge domains, the CMABM can tailor recommendations that align with the client's understanding and comfort level with different financial instruments.

Additionally, incorporating data on total net worth and future commodities knowledge cam provide a comprehensive view of the client's financial landscape and potential investment interests. This data can be crucial for tailoring recommendations to align with each client's unique financial situation and objectives, thereby increasing the likelihood of client engagement and satisfaction.

The decentralized nature of a database can ensure that this data is both accurate and contextually relevant, as it may be managed by domain-specific teams that understand the intricacies of each data product. This rich, multi-dimensional data set can enable the CMABM to deliver highly personalized and relevant advice, enhancing the client's investment experience by aligning recommendations with the client's financial goals, risk tolerance, and knowledge base.

Indeed, in the development of the CMABM, ensuring data quality and consistency can be crucial, particularly when dealing with client investment and wealth data. Initially, the user features data frame may be filtered to remove entries with placeholder values (‘-’) and duplicates may be eliminated to ensure that the data remaining are both relevant and unique.

This step may be crucial for maintaining a clean dataset that accurately reflects client interactions. Another data column may be created to capture the diversity of products associated with each client identifier, providing insights into client interactions and preferences. Additionally, standardizing the data, e.g., standardizing product names to lower case can reduce inconsistencies due to case variations, ensuring uniformity across the dataset.

A response data column may be generated to identify whether a product is related to a brokerage product, using a binary indicator that facilitates the CMABM's training. The data may further be refined by categorizing products into “brokerage” or “other products” and sorting them for consistency. Missing values may be addressed using a fill function that fills the missing values or “not applicable” values with default numerical and object-type columns to ensure no gaps in the dataset.

The envelope data frame category may be prepared by selecting relevant features and encoding categorical variables using one-hot encoding, which can be crucial for machine learning models like the CMABM. The data may be split into training datasets and testing datasets, with the training data used to derive decisions, rewards, and contexts for the CMABM.

The decisions variable may be derived from an item identifier column of the training dataset data frame, representing the specific brokerage products recommended to clients. By converting this column into a list, the CMABM can easily access and iterate over the recommended items during training. Similarly, the rewards variable may be extracted from the response column, which indicates whether a brokerage product recommendation was successful (e.g., whether it was related to a brokerage product) or not (e.g. not related to a brokerage product). This binary reward system can be important for evaluating the effectiveness of each recommendation and guiding the learning process of the CMABM.

The contextual features utilized by the CMABM may be constructed by merging training data with client features data frame associated with the client ID. Thus, ensuring that each recommendation is accompanied by relevant client features. By dropping the client ID, item ID, and response columns, the resulting contexts matrix may focus solely on the features that describe the client's profile. Thus, providing the CMABM with the necessary context to make informed recommendations.

This matrix may then be converted into a list of lists, facilitating its use in various algorithms of the CMABM. The same process is applied to the testing data to create contexts testing data, ensuring consistency between training and testing phases of the CMABM. This structured approach to organizing decisions, rewards, and contexts can be fundamental for training a robust and effective CMABM that can adapt to client preferences and improve the CMABM over time.

Continuing with the example detailed system operational framework 700, the CMABM (which may also be denoted as the contextual bandit algorithm) may include various components such as the policy/algorithm/learning algorithm, reward (e.g., an estimated reward, the expected reward function, etc.), the bandit model (e.g., a multi-armed bandit model), and an agent (e.g., a chatbot for interacting with the client). The CMABM may also include a library for definitions.

The CMABM may generate a prediction of an action comprising a personalized recommendation of the brokerage product as derived from the CMABM for display to a client. The fast application program interface (API) may be a platform/interface for managing and displaying the CMABM while maintain security protocols.

Continuing with the example detailed system operational framework 700, an employee of the business organization operating the pertinent line of business (e.g., a financial portfolio manager or advisor) can access the CMABM via a connect platform. The connect platform may have various targeted connect applications that can provide additional contextual data to the CMABM via a brokerage recommendation user interface (UI) that can enable interactions between the financial portfolio manager or advisor and CMABM. Additionally, feedback may also be provided to the CMABM using the brokerage recommendation UI. The feedback may include feedback from the financial portfolio manager or advisor regarding the recommendation. This feedback may then be incorporated as part of the feedback loop mechanism to train, update, and improve the CMABM and its operation and performance.

Continuing with the example detailed system operational framework 700, the framework also provides a technological improvement through CMABM, its operation and implementation as part of the electronic brokerage recommendation engine. For instance, the particular manner in which the CMABM is generated, trained, and fine-tuned in order to provide the brokerage product recommendation is a technological improvement over the standard machine learning models in the status quo used for providing recommendations. Additionally, the technological improvement is also provided via the construction of the overall framework, which includes an implementation of the electronic brokerage recommendations engine comprising the CMABM with an agent in conjunction with the fast API, the digital data source platform, and the connect platform with various targeted connect applications. The construction showing an exemplary configuration of the framework that implements the CMABM as part of the framework to provide brokerage product recommendations.

Continuing with the example detailed system operational framework 700, further details of the generation of the CMABM may be subsequently described. Starting from the inputs, the detailed process may include receiving inputs, generating the CMABM, and creating the predictive outputs. The detailed example process may include the incorporation of various learning algorithms in the CMABM that may include the various learning algorithms as described above to create outputs for recommending the brokerage product.

An initial step in the detailed example process may include receiving input data related to a brokerage product. The input data may include a user metric and at least one from among a market trend, a product performance metric, and a historical investment data. The user metric may include a user demographic and a user identification. For instance, the user metric may include client investment and wealth information, risk profile score, owner role type, etc. The historical investment data comprises at least one from among a historical transaction data, a past action, and a past outcome.

Another step may include extracting relevant features from the input data, including user demographic features (e.g., job, location, gender, age, etc.), user identification (e.g., name, etc.), client investment and wealth features, and contextual features (e.g., financial data, market trends, time of day, day of the week, etc.). These extracted relevant features may be transform from categorical features into numerical representations (e.g., using one-hot encoding) for the CMABM's compatibility.

Another step may include selection of a learning algorithm as part of the generation of the CMABM. The determination and selection of the learning algorithm for incorporation into the CMABM as part of the generation of the CMABM may include consideration of the problem being solved and the available data to solve the problem.

For instance, the selection of the linear greedy learning algorithm would be, as described above, the need to balance exploration concept and exploitation concept of the CMABM by enabling a selection of an action (e.g., recommendation of the brokerage product) with the highest estimated reward (e.g., click-through rate) based on linear models.

In another example, the selection of the KNN algorithm may be due to the need to recommend the brokerage product based on similar historical contexts. In another example, the selection of the random algorithm by itself may be due to a need to recommend the brokerage product randomly without considering historical data or context. In another example, the selection of the popularity algorithm by itself may be due to a need to recommend popular brokerage products based on historical data, regardless of context regarding a client or a context of portfolio manager/advisor.

In another example, the selection of the clusters algorithm may be due to a need to group similar contexts into clusters and recommend the brokerage product based on the cluster's historical performance. In another example, the selection of the radius algorithm may be due to a need to recommend the brokerage product within a certain radius of the current context, considering similarities in historical data.

In another example, the selection of the LSHNN algorithm may be due to a need to find nearest neighbors efficiently and recommend the brokerage product based on their historical performance. In another example, the selection of the cluster Thompson sampling algorithm may be due to simply needing to balance the exploration concept and the exploitation in a contextual setting of the CMABM.

Continuing with the steps, another step in the detailed example process may include training the CMABM. The training of the CMABM may involve training each algorithm using historical investment data to estimate the reward associated with different actions (e.g., recommendation of the brokerage product) given the contextual features. These algorithms may also be updated by updating the algorithm's model parameters based on the chosen algorithm's update rule (e.g., gradient descent for linear greedy, distance metrics for KNN, etc.). Examples of the distance metrics for the KNN may include, but are not limited to Euclidean distance, Manhattan distance, Minkowski distance, Hamming distance, etc.

Another step may include predicting an action comprising a recommendation for the brokerage product as derived from the CMABM based on the selected algorithm being incorporated into the CMABM. For instance, if the selected algorithm is linear greedy, then the predicted action may relate to selecting the recommendation for the brokerage product with the highest estimated reward based on the linear model. If the selected algorithm is KNN, then the predicted action may relate to recommending the brokerage product based on historical data from the KNN of the current context. If the selected algorithm is random, then the predicted action may relate to randomly selecting a recommendation for the brokerage product without considering historical data.

If the selected algorithm is popularity, then the predicted action may relate to recommending the most popular brokerage product regardless of context. If the selected algorithm is clusters, then the predicted action may relate to recommending the brokerage product based on the cluster's historical performance. If the selected algorithm is radius, then the predicted action may relate to recommending the brokerage product within a certain radius of the current context.

If the selected algorithm is LSHNN, then the predicted action may relate to finding nearest neighbors efficiently using locality-sensitive hashing and recommending the brokerage product based on their historical performance. If the selected algorithm is cluster Thompson sampling, then the predicted action may relate to using Thompson Sampling within clusters to balance the exploration concept and exploitation concept of the CMABM.

Another step in the detailed example process may include updating the CMABM. The CMABM may be updated based on the hyperparameters used and the selected algorithm's update rule.

Another step in the detailed example process may include outputting the predicted action to a client. For instance, the outputting may be the CMABM outputting the recommended brokerage product to the client based on the selected algorithm's decision and the best hyperparameters utilized.

Another step in the detailed example process may include a performance evaluation of the CMABM. This may be achieved by evaluating the performance of each algorithm incorporated in the CMABM over time using relevant metrics to assess effectiveness and identify areas for improvement. By following these steps and incorporating a variety of algorithms into the CMABM, the CMABM can generate timely and personalized recommendations for the brokerage product, enhancing the client experience.

To ensure an optimal performance of the CMABM, several conditions may be implemented. One condition may relate to feature space complexity, wherein the input parameters should be well-defined and relevant to the recommendation task. This is because incorporating too many irrelevant features can increase the complexity of the CMABM without necessarily improving performance.

Another condition may relate to data quality and consistency since the effectiveness of the CMABM relies on the quality and consistency of the input data. Thus, inaccurate or inconsistent data can lead to sub-optimal recommendations.

Another condition may relate to the contextual information, wherein the CMABM relies on contextual information to make recommendations. Therefore, the input parameters should capture relevant contextual information about the client, the market trends, and the framework of the system environment in which the recommendation is being made.

Another condition may relate to scalability, wherein the CMABM's scalability may be limited by the dimensionality of the input feature space and the computational resources available for training and inference.

Another condition may relate to exploration versus exploitation trade-off. The CMABM needs to balance exploration (trying new recommendations to learn more about their effectiveness) and exploitation (leveraging known effective recommendations) based on the input parameters and the current state of knowledge.

Another condition may relate to generalization such that the CMABM may be able to generalize well to unseen contexts or situations. Therefore, the input parameters should capture the essential characteristics of the recommendation task without overfitting to specific instances or scenarios.

Another condition may relate to ethical and legal considerations. This may be because the input parameters should adhere to ethical and legal guidelines regarding privacy, fairness, and transparency. Certain types of information may be off-limits or require special handling to ensure compliance like personally identifiable information.

Another condition may relate to model interpretability. That is, the interpretability of the CMABM's recommendations may be limited by the complexity of the input parameters. Therefore, it may be essential to strike a balance between the CMABM's performance and interpretability. By carefully considering these limitations and boundaries when selecting and defining input parameters, a more effective and robust CMABM may be designed for recommending the brokerage product.

To test whether the CMABM has optimal performance, wherein these conditions are implemented, the CMABM may be subjected to testing in diverse scenarios for vigorous evaluations to test the CMABM's robustness and repeatability. One testing scenario, the CMABM may be tested with varying client contexts and market trends to ensure its adaptability and effectiveness across a broad spectrum of clients.

Indeed, implementation testing of the CMABM may be a comprehensive process that ensures the CMABM's alignment with its design specifications and verifies its operational efficacy. As such, this testing phase is crucial for confirming that the CMABM's implementation accurately reflects the theoretical framework and functional requirements established during development. Therefore, the test phase may involve rigorous assessments of the CMABM's correctness to ensure that its outputs are accurate and consistent with expected results based on given inputs.

Repeatability testing may further validate the CMABM's reliability by confirming that it consistently produces the same results under identical conditions, which is essential for maintaining trust in its recommendations. Additionally, the testing process may also extend to the deployment phase, where the CMABM is integrated into the brokerage's electronic operational system environment and front-end interface, such as an open-source application framework for implementing/hosting and delivering interactive applications.

This testing in the deployment phase may also involve evaluating the CMABM's performance in real-time scenarios, ensuring that it can handle live data streams and deliver timely, relevant recommendations to clients through an intuitive and user-friendly interface. Additionally, deployment testing also checks for seamless integration with existing systems and the front-end application, verifying that the CMABM interacts correctly with other components and provides a smooth experience for the client. By thoroughly testing both the implementation and deployment, including the front-end interface, the business organization can ensure that the CMABM functions as intended: offering accurate, consistent, and actionable insights that enhance client engagement and satisfaction.

In addition to the implementation testing of the CMABM, another type of testing, such as sensitivity analysis of the CMABM may also be performed. Sensitivity analysis in CMABM may involve assessing the robustness of the CMABM's recommendations to changes in various factors, such as the choice of hyperparameters, feature selection, etc.

An example of sensitivity analysis may include hyperparameter tuning sensitivity. This may be performed by investigating how changes in hyperparameters affect the CMABM's performance and recommendations. This may include parameters such as learning rate, exploration-exploitation trade-off using τ, L1, and L2. Experiments may be performed with different values of these hyperparameters to evaluate their impact on the CMABM's performance metrics.

Another example of sensitivity analysis may include feature sensitivity analysis. This may involve assessing the sensitivity of the CMABM to different features or combinations of features by increasing or reducing number of features. This may involve analyzing the importance of individual features and understanding how changes in feature values impact the model's recommendations. Experiments may be performed where specific features are perturbed or removed and observing the resulting changes in the CMABM's behavior and performance. For instance, the features for perturbation or removal as part of the experiment may include, but are not limited to: line of business code, owner role type, current federal income tax of the client, annual income value, cash equivalents value of assets, investible assets value, total debt value, total net worth value, risk profile score, fixed annuities value and knowledge, annual expenses exceeding income value, diversification of investment products, etc. Definitions of several of these features may be provided below.

A risk profile score may typically be used to assess the level of risk associated with a particular entity or decision. An owner role type may refer to a classification or category of roles that an owner (i.e., a client) can have. Current federal income tax of the client may refer to the specific tax bracket that the client or entity affiliated with the client can fall into under the current federal tax system. Annual expenses exceed income may refer to a financial situation where a client's or entity's annual expenses are greater than an annual income.

The fixed annuities value and knowledge information may refer to fixed annuities value and knowledge. A risk profile score may refer to a specific numerical value or parameter used in calculating or representing a risk profile score within a particular system or model or algorithm or engine. This numeric value could be an input or a derived parameter that plays a role in determining the overall risk profile score. The annual income value may refer to specific numerical representation of an client's or entity's annual income.

The cash equivalents value of assets may refer to short-term, highly liquid investments that are easily convertible to a known amount of cash and are subject to an insignificant risk of changes in value. Common examples of cash equivalents include Treasury bills, money market funds, or commercial paper. They are typically used by companies and individuals to manage liquidity and ensure that funds are readily available for immediate needs.

The investible assets value may refer to assets that are available to be invested in various financial instruments or opportunities. Investible assets typically include cash, stocks, bonds, mutual funds, exchange-traded funds (ETFs), or other liquid assets that can be easily converted into investments.

The total debt value may refer to specific numerical amount or value of total debt owed by an individual or organization. The total net worth value may refer to a specific numerical amount or worth of the net worth. It may represent the total monetary value after subtracting liabilities from assets.

Analysis of recommendation outputs from the CMABM upon a perturbation or removal of one or more of these features may provide valuable insights into the CMABM's sensitivity and robustness. By systematically excluding one variable at a time, changes in the CMABM's performance metrics may be observed. Such observable changes may be related to the CMABM's accuracy, precision, and recall, which indicate the significance of each variable in driving the recommendation outcomes.

For instance, removing total debt value as a feature may reveal its role in assessing a client's financial leverage and risk profile, potentially leading to less accurate risk assessments and sub-optimal product suggestions. Similarly, excluding total net worth may impact the CMABM's ability to tailor recommendations based on a client's overall financial standing, affecting the relevance of investment options presented. Removing the diversification of investment products feature, which may reflect the diversity of products a client interacts with, may influence the CMABM's understanding of client preferences and engagement levels. By evaluating the effects of these omissions, it may be identified which variables are critical for maintaining the CMABM's predictive power and ensure that the most influential factors are retained. This process not only enhances the CMABM's robustness but also informs future data collection and feature engineering efforts, ultimately leading to a more optimized CMABM that can generate a more precise and optimized personalized brokerage product recommendations.

Continuing on, another example of sensitivity analysis may include contextual sensitivity. This may include exploring how the CMABM's recommendations vary across different contexts or client segments by analyzing whether the CMABM's recommendations are consistent across different subsets of the data or if certain contexts lead to more uncertainty or variability in the recommendations. This may involve segmenting the data based on the client demographics like location/region, behavior, or other contextual factors and evaluating the CMABM's performance within each segment.

Another example of sensitivity analysis may include algorithm sensitivity. This may include comparing the performance of different algorithms incorporated into the CMABM or variations of the same algorithm by evaluating how sensitive the CMABM's recommendations are to the choice of algorithm and identify which algorithms are most effective for the recommendation task. Experiments may be performed with other algorithms such as epsilon-greedy, Thompson sampling, or linear upper confidence bound and assess their performance under various conditions.

Another example of sensitivity analysis may include robustness to noise and outliers. This may be performed by assessing the robustness of the CMABM to noise and outliers in the data. Noise or anomalies may be introduced into the training data and then evaluate how the CMABM's recommendations are affected. This helps to understand whether the CMABM's performance is resilient to noisy data or if it tends to overfit or underperform in the presence of outliers.

By conducting sensitivity analysis in the CMABM, insights can be gained into the robustness and reliability of the CMABM's recommendations and areas for improvement or optimization may be identified.

In addition to the sensitivity analysis of the CMABM to optimize its performance, another process such as overfitting reduction may also be performed to optimize the CMABM's performance. Reducing overfitting in the CMABM may involve several strategies to ensure that the CMABM generalizes well to unseen data while effectively learning from the available context.

One example technique may include regularization. This may include applying regularization techniques such as L1 or L2 regularization to the LSHNN algorithm to penalize large weights in the CMABM. Regularization helps to prevent the CMABM from fitting noise in the training data and encourages it to learn more robust patterns.

Another example technique may include feature engineering. That is, by carefully designing and selecting relevant features for the CMABM. Too many irrelevant features can lead to overfitting.

Another example technique may include cross-validation. This may include utilizing cross-validation techniques to evaluate the CMABM's performance on multiple folds (manifolds) of the data. This may help ensure that the CMABM's performance is consistent across different subsets of the data and can help identifying overfitting.

Another example technique may include model complexity. This may include considering using simpler model architectures or reducing the complexity of the CMABM to prevent overfitting. A complex model, such as CMABM, with a large number of parameters are more prone to overfitting, especially when the training data is limited.

Another example technique may include data augmentation. This may include augmenting the training data by introducing variations or perturbations to the input features by increasing or reducing number of features or contexts. This may help expose the CMABM to a more diverse range of scenarios and reduces the risk of overfitting to specific instances in the training data.

By applying these techniques, overfitting may be reduced in the CMABM and improve the CMABM's performance.

Additionally, optimizing the product recommendation modeling functionality for client's investment portfolio by implementing the CMABM and its operational framework may be coupled with strategic tuning of hyperparameters such as epsilon (E), number of clusters, and tau (t), presents a sophisticated approach to enhancing user experience and operational system efficiency.

The CMABM can enable a product recommendation by dynamically adapt its behavior based on contextual cues, such as client preferences, market characteristics, and workflow patterns. By leveraging epsilon-greedy exploration strategies, the CMABM can balance the exploration of new options (the epsilon element) with exploiting known effective strategies, ensuring continual improvement in the CMABM's operational performance.

Additionally, when incorporating cluster type algorithms in the CMABM, the selection of the number of clusters can be pivotal in organizing contextual information efficiently. Through clustering, similar contexts are grouped together, allowing the CMABM to generalize learning across related scenarios. Optimal clustering facilitates effective decision-making, striking a balance between the CMABM's complexity and accuracy.

Additionally, the hyperparameter τ, governing the degree of exploration versus exploitation, may play a crucial role in fine-tuning the CMABM's responsiveness to new information. By adjusting t, the CMABM can regulate the extent to which it prioritizes exploring new actions versus exploiting known high-reward actions, thereby optimizing its performance over time.

In essence, the integration of the CMABM, as part of an electronic brokerage recommendation engine as shown in FIG. 7, with carefully calibrated hyper-parameters can enable an CMABM and the electronic brokerage recommendation engine to continually learn and adapt, ensuring efficient data processing and a seamless user experience. Through iterative refinement guided by real-time feedback, the CMABM can deliver tailored solutions that align closely with client's needs and preferences, thereby maximizing utility and client satisfaction.

The rationale for selecting a final list of hyper-parameters for the CMABM is to enable a strategic approach to balancing exploration concept and exploitation concept while optimizing performance. For instance, the choice of three clusters for algorithms like cluster Thompson Sampling, clusters, and KNN may suggest a consistent strategy to simplify the decision-making process by grouping similar contexts, e.g., based on prior knowledge or empirical analysis indicating three distinct segments within the data.

The use of ε=0.1 in clusters, KNN, and tree bandit algorithms may indicate a preference for exploitation with a controlled level of exploration, ensuring that the CMABM can leverage known information effectively while still exploring enough to avoid local optima. In the softmax method, a τ value of 4 may be chosen to allow for more exploration, which may be crucial in environments with high uncertainty or complexity, as it flattens the probability distribution over actions and encourages trying less certain options.

For the LSHNN algorithm, the parameters l₁=15 and l₂=2 may be selected to balance search accuracy and computational efficiency, ensuring that the CMABM can efficiently handle nearest neighbor searches. Overall, these hyper-parameters are likely the result of careful empirical testing and domain expertise, aimed at achieving a robust and efficient learning process tailored to the specific characteristics of the task.

In formulating the CMABM, the choice of candidate variables can be pivotal, particularly in the context of identifying and incorporating key risk drivers. These variables may be selected based on their potential impact on client investment decisions and their ability to capture the nuances of market dynamics and client profiles. The initial set of candidate variables may include a comprehensive range of financial metrics and client attributes, such as but not limited to, risk tolerance scores, investment knowledge levels, income, net worth, and historical transaction data, etc.

The variable reduction process may begin with an exploratory data analysis (EDA) to identify variables with significant missing values or low variance, leading to the elimination of e.g., 10% of the initial variables. Next, correlation analysis may be conducted to remove highly correlated variables, retaining only one representative from each correlated group, which results in a further reduction of e.g., 15% of the variables. Following this, feature importance techniques, such as random forest or gradient boosting, may be employed to rank variables based on their predictive power, allowing for the exclusion of the bottom (e.g., bottom 20%) least important variables.

In the application of the CMABM for recommending the brokerage product recommendation, comparing various algorithms may be essential for identifying the most effective approach. Beginning with benchmark models by invoking random and popularity algorithms, these serve as foundational baselines for assessing the performance of more complex algorithms. The random algorithm may assign actions randomly, providing a simple yet necessary benchmark for evaluating whether more sophisticated algorithms offer tangible improvements. Meanwhile, the popularity algorithm may recommend actions based on historical data, prioritizing those with the highest observed success rates. Although straightforward, this approach may lack adaptability to changing contexts and fail to capture nuanced patterns in client behavior.

Moving to more advanced algorithms, the KNN and LSHNN algorithms leverage the similarity of contexts to make recommendations. KNN may identify the k most similar contexts to the current context and selects actions based on their outcomes, while LSHNN may efficiently approximate nearest neighbors, facilitating faster recommendation generation. These algorithms may excel in scenarios where context similarity is crucial, allowing for personalized recommendations tailored to individual client's preferences.

Cluster algorithms, such as k-means clustering, partition the data into clusters based on contextual features and recommend actions based on cluster centroids or cluster-specific policies. By grouping similar contexts together, cluster algorithms capture underlying patterns and preferences shared among clients within each cluster, enabling more targeted recommendations. However, the effectiveness of cluster algorithms heavily depends on the quality of feature representation and the choice of clustering parameters.

When comparing these approaches in terms of recall, which measures the proportion of relevant items retrieved among all relevant items, and normalized discounted cumulative gain, which considers both the relevance and the position of items in the recommendation list, then KNN, LSHNN, and clustering algorithms generally outperform random and popularity algorithms. By leveraging contextual information, these algorithms can provide more relevant and personalized recommendations, leading to higher recall and normalized discounted cumulative gain scores. However, the performance may vary depending on the quality of the contextual features, the choice of algorithm parameters, and the nature of the recommendation task. Therefore, thorough experimentation and evaluation are necessary to determine the most effective approach as to which algorithm is incorporated into the CMABM based on evaluating recall and normalized discounted cumulative gain terms.

Given the various testing measures and techniques described above to help the CMABM to perform optimally, ongoing performing monitoring (OPM) of the CMABM may be needed to continuously monitor the performance of the CMABM to ensure its optimal performance. OPM may refer to the set of on-going testing activities to be performed by the developers or their delegates in order to establish that the CMABM continues to perform as intended and to provide a periodic measure of model uncertainty where applicable.

When monitoring the performance of the CMABM for brokerage product recommendations, it may be essential to select performance metrics that align with the CMABM's success criteria and that can help to identify atypical performance in a timely manner. Some examples of performance metrics to consider, along with the rationale for early warning assessments, are provided below. These are meant to be examples and the performance metrics are not limited to just these examples.

One example of a performance metric of high relevance may be a click-through rate (CTR). The CTR may be defined as the ratio of clients who click on a recommendation to the total number of clients who view the recommendation. The rationale for using the CTR as a performance metric is because it may be a direct measure of client engagement and the effectiveness of the recommendations. A high CTR indicates that the recommendations are relevant and appealing to clients. Additionally, the CTR can also serve as an early warning because monitoring the CTR within shorter performance windows can quickly identify drops in client engagement, allowing for timely intervention.

Another example of a performance metric of high importance may be a conversion rate. The conversion rate may be defined as the ratio of clients who take a desired action (e.g., signing up for a brokerage account) after clicking on a recommendation to the total number of clients who click. The rationale for using the conversion rate as a performance metric is because it measures the ultimate success of the recommendations in driving desired actions, which is critical for business objectives. Additionally, the conversion rate can also serve as an early warning because early detection of drops in conversion rates can help address issues before they significantly impact business outcomes.

Other examples of performance metrics in another embodiment may be precision and recall. Precision may be defined as the proportion of relevant recommendations among the recommended items. Recall may be defined as the proportion of relevant recommendations that were successfully recommended out of all possible relevant items. The rationale for using precision and recall as performance metrics is because they may be important for understanding the accuracy and completeness of the recommendations. High precision ensures that clients are not overwhelmed with irrelevant recommendations, while high recall ensures that relevant options are not missed. Additionally, precision and recall can also serve as an early warning because by monitoring these metrics within shorter windows can help to identify issues with recommendation relevance and coverage early on.

Another example of a performance metric may be mean average precision at k (MAP@K). The MAP@K may be defined as the mean of the average precision scores for the top K recommendations. The rationale for using the MAP@K as a performance metric is because it may provide a single metric that balances precision and recall, focusing on the top K recommendations, which are often the most critical for user engagement. Additionally, the MAP@K can also serve as an early warning because early assessments of MAP@K can help to ensure that the most important recommendations remain relevant and accurate.

Another example of a performance metric of importance may be normalized discounted cumulative gain (NDCG). The NDCG may be defined as a measure of ranking quality that accounts for the position of relevant recommendations in the list. The rationale for using the NDCG as a performance metric is because it may be useful for evaluating the quality of ranked recommendations, ensuring that the most relevant items are presented higher in the list. Additionally, NDCG can also serve as an early warning because early detection of drops in NDCG can help maintain the quality of the recommendation ranking.

Another example of a performance metric may be a hit rate. The hit rate maybe defined as the proportion of clients who find at least one relevant recommendation in the top N recommendations. The rationale for using the hit rate as a performance metric is because it may be a simple yet effective measure of the CMABM's ability to provide at least one relevant recommendation, which is crucial for client satisfaction. Additionally, the hit rate can also serve as an early warning because monitoring the hit rate within shorter windows can quickly identify issues with recommendation relevance.

Another example of a performance metric may be area under the curve (AUC), which measures the CMABM's ability to distinguish between positive and negative instances. These metrics collectively offer a nuanced understanding of how well the CMABM is performing in terms of discrimination, relevance, ranking, and precision-recall trade-offs. These performance metrics may be plotted using x-y axis displays, wherein each line on the plot may represent different algorithms and display the value (y-axis) of a given performance metric at different top-k (x-axis) for each of the algorithms.

The OPM of the CMABM may also involve a comprehensive evaluation framework with first and second thresholds. These thresholds are typically based on key performance metrics such as “average reward” or “exploration-exploitation balance”. The higher metrics may signify critical performance indicators that require immediate attention if breached beyond the first threshold, indicating a severe deviation from the desired outcome. These might include metrics such as click-through rates and time spent on recommended products, providing insights into client interest and satisfaction. This means that the algorithm may explore excessively, indicating that it has not yet learned the optimal actions. Average reward is significantly below the maximum and the algorithm selects the sub-optimal action most of the time.

The lower metrics represent optimal performance indicators, and meeting or surpassing the first threshold indicates satisfactory system performance. However, breaching the second threshold for lower metrics suggests a declining trend that requires proactive intervention to maintain satisfactory performance levels. The algorithm primarily exploits, indicating it has learned the optimal actions. Average reward is close to the maximum possible reward and the algorithm selects the optimal action most of the time.

The metrics in-between the higher and lower metrics may serve as intermediate indicators, signaling areas where performance may be satisfactory but could benefit from further optimization. Monitoring these metrics allows for timely adjustments to the CMABM, ensuring that the product recommendation system remains agile and responsive to evolving client needs and business objectives. By employing this multi-tiered approach to performance monitoring, the CMABM can effectively balance system stability with the continuous pursuit of improvement and innovation. The algorithm balances exploration and exploitation. The algorithm selects the optimal action some of the time and the average reward is moderately below the maximum.

These formulations of the various metrics ensures that the thresholds dynamically adapt to changes in the distribution of performance metrics. Specifically, the first threshold may be set based on the mean and standard deviation of the metric, providing a baseline for performance evaluation. The second threshold may then be set at a certain distance from the first threshold, allowing for a more nuanced assessment of performance. By continuously monitoring the performance metrics and comparing them to the dynamically adjusted thresholds, the CMABM can make informed decisions about when to take actions to improve the brokerage product recommendation. For instance, an exploitation-exploration ratio measures the balance between exploring new actions and exploiting known good actions, and can be quantified as the fraction of time the algorithm chooses actions others than the current best estimate. As such, this mathematical formulation may provide a robust framework for setting thresholds that are sensitive to changes in performance metrics while allowing for flexibility in adaptation over time.

The comprehensive framework may be designed to evaluate the effectiveness of various algorithms for incorporation into the CMABM. The effectiveness of these algorithms in delivering personalized investment advice as part of the CMABM may be evaluated. This effectiveness may be assessed using predetermined thresholds correlating with the threshold metrics to provide a clear framework for performance evaluation.

These thresholds help the brokerage monitor and compare the performance of different algorithms for incorporation into the CMABM, prioritize areas for improvement, and ensure that the recommendation system consistently delivers value to clients. By using these thresholds, the electronic brokerage recommendation engine can effectively manage the CMABM's performance, aligning it with client expectations and business goals. It is noted that these values are used for illustrative purposes and are not meant to limit the thresholds to only these values.

Indeed, in selecting the preferred algorithm for incorporation in the CMABM for brokerage product recommendation, several critical criteria are considered to ensure optimal performance and applicability.

One criteria can be fit, wherein fit can be evaluated using metrics such as receiver operating characteristic for area under the curve (ROC AUC) and precision-recall AUC to assess the CMABM's ability to accurately distinguish between relevant and irrelevant brokerage product recommendations.

Additionally, metrics like hit rate, NDCG, CTR, and MAP may be employed to measure the CMABM's effectiveness in ranking and relevance, ensuring that the most pertinent brokerage products are recommended.

Another criteria may be speed. Speed may be crucial in a real-time brokerage environment, where timely recommendations can significantly impact client decisions and financial outcomes. The model must process data and generate recommendations swiftly to maintain client engagement and satisfaction.

Thus, the CMABM's complexity should be balanced to avoid overfitting and ensure computational efficiency, allowing the CMABM to remain interpretable while capturing essential patterns in client behavior. Robustness may be used to assess the CMABM's ability to maintain consistent performance across different scenarios, handling noise, missing data, and shifts in client behavior effectively.

By clearly defining and prioritizing these criteria, the selection process aims to identify an algorithm for incorporation into the CMABM that not only performs well on historical data but also adapts to the dynamic and evolving nature of client interactions in brokerage product recommendations, ultimately enhancing client experience and business outcomes.

Thus, when evaluating an algorithm for incorporation into the CMABM, it may be important to calculate the selected criteria (e.g., such as ROC AUC, precision-recall AUC, hit rate, NDCG, CTR, and MAP) across the training, validation, and test datasets. This comprehensive evaluation ensures that the algorithm and CMABM not only learns effectively from the training data but also generalizes well to unseen data.

Additionally, live data for testing the CMABM is needed to evaluate the CMABM's effectiveness and accuracy in real-world applications. Such testing can provide the dynamic and authentic context necessary for a thorough assessment of the CMABM's performance. Specifically, gaining access to pilot production data can be crucial, as it allows for observation and analysis of whether portfolio managers/advisors are actually utilizing and providing the CMABM's recommendations to their clients.

The test data is invaluable because it not only reflects the CMABM's predictive capabilities, but also its practical utility and acceptance among portfolio managers/advisors. By understanding how often and under what circumstances portfolio managers/advisors choose to follow the CMABM's suggestions, additional insights can be gained into the strengths CMABM and areas where the CMABM might be primed for improvement. This feedback loop can be essential for refining the CMABM, ensuring it aligns with both portfolio managers/advisors' expectations and the client's needs. Thus, access to pilot production data can serve as a pivotal step in validating the CMABM's real-world applicability, ultimately enhancing its reliability and effectiveness in supporting advisors to make informed, client-centric decisions.

Indeed, in the development of the CMABM, fine-tuning techniques play a crucial role in optimizing performance and ensuring the CMABM's investment and wealth for practical use. One of the chosen techniques can be K-fold cross-validation, a robust technique for assessing the CMABM's generalizability and preventing overfitting.

By dividing the dataset into K subsets, or “folds” and iteratively training the model on K−1 folds while validating it on the remaining fold, this approach can provide a comprehensive evaluation of the CMABM's performance across different data segments. Implementing K-fold cross-validation can allow for a more reliable estimate of the CMABM's accuracy and robustness, as it ensures that every data point be used for both training and validation.

Thus, K-fold cross-validation can be used to assess the performance and generalizability of the CMABM. In K-fold cross-validation, the dataset can be divided into K equally sized folds or subsets.

The CMABM may be trained on e.g., on 80% of these folds and tested on the remaining e.g., 20% fold of data. This process can be repeated twice, with each fold serving as the test set once, and the results are averaged to provide an overall performance metric.

This technique may help in mitigating overfitting and provides a more reliable estimate of the CMABM's performance on unseen data. Regarding the splitting of training data and test data, in K-fold cross-validation, each run involves a different split, ensuring that every data point is used for both training and testing datasets.

The results for each run can typically include performance metrics such as accuracy, precision, recall, or F1-score, depending on the problem type. As for parameter stability, K-fold cross-validation can reveal whether the CMABM's parameters are consistent across different data splits. The performance metrics are stable across each run suggesting that the model's parameters are robust and not overly sensitive to the specific data used for training. Conversely, significant variability in results might indicate the need for further tuning or a more complex model to capture the underlying patterns in the data effectively.

This technique can be expected to enhance the CMABM's predictive capabilities by identifying the optimal hyper-parameters and configurations that yield the best performance across all folds. The iterative nature of this process can help in fine-tuning the CMABM to better capture the nuances of client preferences and market dynamics, ultimately leading to more accurate and personalized brokerage product recommendations. By leveraging K-fold cross-validation, the CMABM may be better equipped to handle the variability and complexity inherent in financial data, making it a suitable and reliable tool for advisors seeking to provide tailored investment advice to their clients.

Additionally, conservationism can also be utilized to enhance the CMABM's predictive capabilities to ensure that the recommendations provided are accurate. By incorporating conservatism into the CMABM's outputs, a balance between exploration concept and exploitation concept can be achieved while still prioritizing precision, recall, MAP, NDCG, AUC score, CTR, and hit rate metrics.

For example, by emphasizing precision, it may be ensured that the recommended brokerage products are highly relevant to the client's needs and context. This helps in minimizing the risk of suggesting irrelevant or inappropriate products, which is particularly crucial in optimizing the investment portfolios of the high net worth clients.

Additionally, a focus on recall ensures that the CMABM does not overlook potentially valuable brokerage products that may be relevant to the client but could be overlooked by overly conservative aspects. Thus, by maintaining a balance between precision and recall, a comprehensive coverage of relevant brokerage products can be provided while avoiding unnecessary recommendations.

Furthermore, incorporating MAP and NDCG metrics would enable an evaluation of the overall quality of recommendations by considering the rank and relevance of the recommended brokerage products. By optimizing these metrics, it can be ensured that the recommendations are not only relevant but also presented in an order that maximizes client satisfaction and utility.

The hit rate for the CMABM may be a key performance metric that measures the effectiveness of the recommendations provided to users. It may be calculated by dividing the number of successful recommendations, or “hits” by the total number of recommendations made. A “hit” may occur when a client engages with a recommended product, such as clicking on it or making a purchase. For example, if 1,000 recommendations are made and 150 result in the client's engagement, then the hit rate would be 15%. This metric can help to assess how well the CMABM aligns with client preferences and can be analyzed over different time frames or client segments for deeper insights. A higher hit rate may indicate more effective recommendations, leading to increased client satisfaction and engagement, and can guide improvements in the CMABM.

Substantiating the conservatism of the CMABM outputs may involve comparing the metrics above between recent data and historical data, e.g., data that is 6 months old, and establishing that both shows the same trends. These approaches help in quantifying and managing the uncertainty associated with recommendation decisions and how the metrics differ using fewer features.

In conclusion, enhancing recommendation performance through conservative outputs of the CMABM may involve prioritizing precision, recall, MAP, and NDCG metrics, while incorporating techniques to ensure the reliability of the recommendations provided. By striking a balance between exploration and exploitation and emphasizing the relevance and quality of recommended times, the client experience and utility of CMABM may be effectively enhanced.

Although the invention has been described with reference to several embodiments, it is understood that the words that have been used are words of description and illustration, rather than words of limitation. Changes may be made within the purview of the attached claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the attached claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the attached claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method of generating a contextual multi-armed bandit model for a personalized recommendation of a brokerage product, the method being implemented by at least one processor, the method comprising:
receiving input data related to a brokerage product;
extracting contextual features from the input data;
generating a contextual multi-armed bandit model (CMABM) based on the extracted contextual features representing an arm of the CMABM and based on a selection of at least one learning algorithm from among a plurality of learning algorithms that maximizes an expected reward function for the CMABM;
optimizing an epsilon-greedy algorithm based on adjusting an epsilon value to provide a balance between an exploitation concept and an exploration concept associated with the CMABM;
predicting an action comprising a personalized recommendation of the brokerage product as derived from the CMABM; and
outputting the predicted action to a user.

2. The method of claim 1, wherein the input data comprises a user metric and at least one from among a market trend, a product performance metric, and a historical investment data;
wherein the user metric comprises a user demographic and a user identification; and
wherein the historical investment data comprises at least one from among a historical transaction data, a past action, and a past outcome.

3. The method of claim 2, further comprising:
training the CMABM based on the historical investment data to estimate a reward associated with the predicted action that maximizes the expected reward function;
performing a feedback loop mechanism as part of the training of the CMABM; and
updating the CMABM based on an updating rule associated with the selected at least one learning algorithm.

4. The method of claim 3, wherein the updating rule comprises at least one from among a predetermined utility maximization rule, a gradient descent function, a distance measurement function, a cosine similarity function, and a probability function; and
wherein the feedback loop mechanism is based on a performance evaluation of the CMABM and at least one from among a user feedback and a changing need of a business organization that utilizes the CMABM.

5. The method of claim 4, wherein the performance evaluation of the CMABM comprises:
analyzing a performance of the CMABM over a predetermined time period based on computing a suite of performance metrics comprising a precision metric, a recall metric, a mean average precision (MAP) metric, and a normalized discounted cumulative gain (NDCG) metric associated with the CMABM.

6. The method of claim 1, wherein the CMABM comprises a reinforcement learning model;
wherein the plurality of learning algorithms comprises a linear greedy learning algorithm, a k-nearest neighbor (KNN) learning algorithm, a randomized popularity learning algorithm, a softmax learning algorithm, a Thompson sampling learning algorithm, a locality-sensitive hashing nearest neighbor (LSHNN) learning algorithm, a cluster learning algorithm, a radius neighborhood learning algorithm, and a tree bandit learning algorithm; and
wherein the expected reward function comprises an argmax function with an estimated reward term representing an exploitation concept and a confidence interval representing an exploration concept.

7. (canceled)

8. A computing apparatus for generating a contextual multi-armed bandit model for a personalized recommendation of a brokerage product, comprising:
a processor;
a memory;
a display; and
a communication interface coupled to each of the processor, the memory, and the display, wherein the processor is configured to:
receive input data related to a brokerage product;
extract contextual features from the input data;
generate a contextual multi-armed bandit model (CMABM) based on the extracted contextual features representing an arm of the CMABM and based on a selection of at least one learning algorithm from among a plurality of learning algorithms that maximizes an expected reward function for the CMABM;
optimize an epsilon-greedy algorithm based on adjusting an epsilon value to provide a balance between an exploitation concept and an exploration concept associated with the CMABM;
predict an action comprising a personalized recommendation of the brokerage product as derived from the CMABM; and
output the predicted action to a user.

9. The computing apparatus of claim 8, wherein the input data comprises a user metric and at least one from among a market trend, a product performance metric, and a historical investment data;
wherein the user metric comprises a user demographic and a user identification; and
wherein the historical investment data comprises at least one from among a historical transaction data, a past action, and a past outcome.

10. The computing apparatus of claim 9, wherein the processor is further configured to:
train the CMABM based on the historical investment data to estimate a reward associated with the predicted action that maximizes the expected reward function;
perform a feedback loop mechanism as part of the training of the CMABM; and
update the CMABM based on an updating rule associated with the selected at least one learning algorithm.

11. The computing apparatus of claim 10, wherein the updating rule comprises at least one from among a predetermined utility maximization rule, a gradient descent function, a distance measurement function, a cosine similarity function, and a probability function; and
wherein the feedback loop mechanism is based on a performance evaluation of the CMABM and at least one from among a user feedback and a changing need of a business organization that utilizes the CMABM.

12. The computing apparatus of claim 11, wherein the processor is further configured to perform the evaluation of the CMABM by:
analyzing a performance of the CMABM over a predetermined time period based on computing a suite of performance metrics comprising a precision metric, a recall metric, a mean average precision (MAP) metric, and a normalized discounted cumulative gain (NDCG) metric associated with the CMABM.

13. The computing apparatus of claim 8, wherein the CMABM comprises a reinforcement learning model;
wherein the plurality of learning algorithms comprises a linear greedy learning algorithm, a k-nearest neighbor (KNN) learning algorithm, a randomized popularity learning algorithm, a softmax learning algorithm, a Thompson sampling learning algorithm, a locality-sensitive hashing nearest neighbor (LSHNN) learning algorithm, a cluster learning algorithm, a radius neighborhood learning algorithm, and a tree bandit learning algorithm; and
wherein the expected reward function comprises an argmax function with an estimated reward term representing an exploitation concept and a confidence interval representing an exploration concept.

14. (canceled)

15. A non-transitory computer readable storage medium storing instructions for generating a contextual multi-armed bandit model for a personalized recommendation of a brokerage product, the non-transitory computer readable storage medium comprising executable code which, when executed by a processor, causes the processor to:
receive input data related to a brokerage product;
extract contextual features from the input data;
generate a contextual multi-armed bandit model (CMABM) based on the extracted contextual features representing an arm of the CMABM and based on a selection of at least one learning algorithm from among a plurality of learning algorithms that maximizes an expected reward function for the CMABM;
optimize an epsilon-greedy algorithm based on adjusting an epsilon value to provide a balance between an exploitation concept and an exploration concept associated with the CMABM;
predict an action comprising a personalized recommendation of the brokerage product as derived from the CMABM; and
output the predicted action to a user.

16. The non-transitory computer readable storage medium of claim 15, wherein the input data comprises a user metric and at least one from among a market trend, a product performance metric, and a historical investment data;
wherein the user metric comprises a user demographic and a user identification; and
wherein the historical investment data comprises at least one from among a historical transaction data, a past action, and a past outcome.

17. The non-transitory computer readable storage medium of claim 16, wherein the executable code further causes the processor to:
train the CMABM based on the historical investment data to estimate a reward associated with the predicted action that maximizes the expected reward function;
perform a feedback loop mechanism as part of the training of the CMABM; and
update the CMABM based on an updating rule associated with the selected at least one learning algorithm.

18. The non-transitory computer readable storage medium of claim 17, wherein the updating rule comprises at least one from among a predetermined utility maximization rule, a gradient descent function, a distance measurement function, a cosine similarity function, and a probability function;
wherein the feedback loop mechanism is based on a performance evaluation of the CMABM and at least one from among a user feedback and a changing need of a business organization that utilizes the CMABM;
wherein the CMABM comprises a reinforcement learning model;
wherein the plurality of learning algorithms comprises a linear greedy learning algorithm, a k-nearest neighbor (KNN) learning algorithm, a randomized popularity learning algorithm, a softmax learning algorithm, a Thompson sampling learning algorithm, a locality-sensitive hashing nearest neighbor (LSHNN) learning algorithm, a cluster learning algorithm, a radius neighborhood learning algorithm, and a tree bandit learning algorithm; and
wherein the expected reward function comprises an argmax function with an estimated reward term representing an exploitation concept and a confidence interval representing an exploration concept.

19. The non-transitory computer readable storage medium of claim 18, wherein the executable code further causes the processor to perform the evaluation of the CMABM by:
analyzing a performance of the CMABM over a predetermined time period based on computing a suite of performance metrics comprising a precision metric, a recall metric, a mean average precision (MAP) metric, and a normalized discounted cumulative gain (NDCG) metric associated with the CMABM.

20. (canceled)

21. The method of claim 1, wherein the balance causes the CMABM to balance: exploring new recommendations to determine at least one corresponding effectiveness of the new recommendations, and exploiting recommendations that are already known to be effective.

22. The computing apparatus of claim 8, wherein the processor is further configured to:
evaluate omissions to identify variables that are critical to maintaining a predictive power of the CMABM.

23. The non-transitory computer readable storage medium of claim 15, wherein the executable code further causes the processor to:
reduce overfitting to ensure that the CMABM generalizes well to unseen data while effectively learning from available context.
